(19) United States
(12) Patent Application Publication
(10) Pub. No.: US 2010/0188584 A1
(43) Pub. Date: Jul. 29, 2010

(54) DEPTH CALCULATING METHOD FOR TWO DIMENSIONAL VIDEO AND APPARATUS THEREOF

(75) Inventors: Kai-Che Liu, Kaohsiung City (TW); Wen-Chao Chen, Kaohsiung City (TW); Jinn-Cherng Yang, Yilan County (TW); Wen-Nung Lie, Chiayi County (TW); Guo-Shiang Lin, Tainan City (TW); Cheng-Ying Yeh, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INDUSTRIAL TECHNOLOGY RESEARCH INSTITUTE, Hsinchu (TW)

(21) Appl. No.: 12/510,428

(22) Filed: Jul. 28, 2009

(30) Foreign Application Priority Data
Jan. 23, 2009 (TW) 98102973

(51) Int. Cl. H04N 5/14

(52) U.S. Cl. 348/699; 348/E05.062

(57) ABSTRACT

A depth calculating method is provided for calculating corresponding depth data in response to frame data, which includes macroblocks. The depth calculating method includes the following steps. First, a type of video is decided according to a video content. A motion vector is obtained from decompressed video information and is modified according to a shot change detection and camera motion data. Then, multiple pieces of macroblock motion parallax data respectively corresponding to the macroblocks are found according to motion vector data of the modified macroblocks. Thereafter, the depth data corresponding to the frame data is calculated according to the pieces of macroblock motion parallax data, variance data, contrast data and texture gradient data.

This application claims the benefit of Taiwan application Serial No. 98102973, filed Jan. 23, 2009, the subject matter of which is incorporated herein by reference.

### BACKGROUND

1. Technical Field

The disclosure relates in general to a video processing method, and more particularly to a depth calculating method for calculating depth data corresponding to input frame data.

2. Description of the Related Art

In the modern age in which the technique is changing with each passing day, the digital content industry including computer motion pictures, digital games, digital learning, mobile applications and services has the flourishing development. In the prior art, the three-dimensional (3D) image/video has existed, and is well expected to enhance the service quality of the digital content industry.

Generally speaking, the existing 3D image/video generator utilizes the depth image based rendering (DIBR) to generate the 3D image data according to the 2-dimensional (2D) image data and the depth data. The precision of the depth data has the final influence on the quality of the 3D image data. Therefore, it is an important subject in the industry to design a depth calculating method of generating the precise depth data.

### SUMMARY

According to a first aspect of the present disclosure, a depth calculating method for calculating corresponding depth data in response to frame data of input video data is provided. The frame data includes u×v macroblocks. Each of the u×v macroblocks includes X×Y pieces of pixel data, wherein u and v are natural numbers greater than 1. The depth calculating method includes the following steps. First, smooth macroblocks are found in the u×v macroblocks. Next, motion vector data of these macroblocks in the u×v macroblocks are set to a zero motion vector. Then, a plurality of neighboring macroblocks is found with respect to each of the u×v macroblocks. Next, motion vector data of each of the u×v macroblocks is set to be equal to mean motion vector data of the neighboring macroblocks. Then, u×v pieces of macroblock motion parallax data respectively corresponding to the u×v macroblocks are found according to the corrected motion vector data of the u×v macroblocks. Finally, the depth data corresponding to the frame data is calculated according to the u×v pieces of macroblock motion parallax data.

According to a second aspect of the present disclosure, a depth calculating apparatus for calculating corresponding depth data in response to frame data of input video data is provided. The frame data includes u×v macroblocks. Each of the u×v macroblocks includes X×Y pieces of pixel data, wherein u and v are natural numbers greater than 1. The depth calculating apparatus includes a motion parallax data module and a depth calculating module. The motion parallax data module generates u×v pieces of macroblock motion parallax data according to motion vector data corresponding to the u×v macroblocks. The motion parallax data module includes a region correcting module, a motion vector data correcting module and a motion parallax data calculating module. The region correcting module finds smooth macroblocks in the u×v macroblocks and sets the motion vector data of these macroblocks in the u×v macroblocks as corresponding to a zero motion vector. The motion vector data correcting module finds a plurality of neighboring macroblocks with respect to each of the u×v macroblocks, and sets the motion vector data of each of the u×v macroblocks to be equal to mean motion vector data of the neighboring macroblocks. The motion parallax data calculating module generates the u×v pieces of macroblock motion parallax data according to the macroblock motion vector data of the u×v macroblocks, corrected by the region correcting module and the motion vector data correcting module. The depth calculating module calculates the depth data corresponding to the frame data according to the u×v pieces of macroblock motion parallax data.

The disclosure will become apparent from the following detailed description of the preferred but non-limiting embodiments. The following description is made with reference to the accompanying drawings.

### BRIEF DESCRIPTION OF THE DRAWINGS

The file of this patent contains at least one drawing executed in color. Copies of this patent with the color drawing(s) will be provided by the Patent and Trademark Office upon request and payment of the necessary fee.

FIG. 1 is a schematic illustration showing frame data Fd1.

FIGS. 2A and 2B are block diagrams showing a depth calculating apparatus according to a first exemplary embodiment of the disclosure.

FIG. 3 is a schematic illustration showing a to-be-tested macroblock DBK and reference macroblocks RBK1 to RBK8.

FIG. 4 is a schematic illustration showing a macroblock BK(s,t) and its neighboring macroblocks NBK1 to NBK8.

FIG. 5 is a flow chart showing a depth calculating method according to the exemplary embodiment of the disclosure.

FIGS. 6A and 6B are block diagrams showing a depth calculating apparatus according to a second exemplary embodiment of the disclosure.

FIG. 7A is a flow chart showing a depth calculating method according to the second exemplary embodiment of the disclosure.

FIG. 7B is a partial flow chart showing the depth calculating method according to the exemplary embodiment of the disclosure.

FIG. 8 is another block diagram showing the depth calculating apparatus according to the second exemplary embodiment of the disclosure.

FIG. 9A is another flow chart showing the depth calculating method according to the second exemplary embodiment of the disclosure.

FIG. 9B is another partial flow chart showing the depth calculating method according to the second exemplary embodiment of the disclosure.

FIG. 10 is still another block diagram showing the depth calculating apparatus according to the second exemplary embodiment of the disclosure.

FIGS. 11A and 11B are still another block diagrams showing the depth calculating apparatus according to the second exemplary embodiment of the disclosure.

FIG. 12A is still another flow chart showing the depth calculating method according to the second exemplary embodiment of the disclosure.

FIG. 12B is still another partial flow chart showing the depth calculating method according to the second exemplary embodiment of the disclosure.

FIG. 13 is still another block diagram showing the depth calculating apparatus according to the second exemplary embodiment of the disclosure.

FIG. 14A is still another flow chart showing the depth calculating method according to the second exemplary embodiment of the disclosure.

FIG. 14B is still another partial flow chart showing the depth calculating method according to the second exemplary embodiment of the disclosure.

FIGS. 15A and 15B are block diagrams showing a depth calculating apparatus according to a third exemplary embodiment of the disclosure.

FIG. 16A is a flow chart showing operations of a motion activity analyzing module 452 of FIG. 15B.

FIG. 16B is a flow chart showing operations of a background complexity analyzing module 454 of FIG. 15B.

FIG. 17 is a flow chart showing operations of a video classifying module 450 of FIG. 15B.

FIG. 18A is a flow chart showing operations of a depth repairing module 456 when input video data Vdi pertains to video type I.

FIG. 18B is a flow chart showing detailed operations in the step (j) of FIG. 18A.

FIG. 19A is a flow chart showing operations of the depth repairing module 456 when the input video data Vdi pertains to video type II.

FIG. 19B is a flow chart showing detailed operations in the step (h′) of FIG. 19A.

FIG. 19C is another flow chart showing detailed operations in the step (h′) of FIG. 19A.

FIGS. 19D and 19E are still another flow charts showing detailed operations in the step (h′) of FIG. 19A.

FIG. 19F is a flow chart showing detailed operations in the step (i′) of FIG. 19A.

FIG. 20 is a flow chart showing the background depth repairing operation of the depth repairing module 456.

FIG. 21 is a schematic illustration showing the depth repairing module 456 performing the background depth repairing operation.

Exhibits 1 to 6 are illustrations of input video data Vdi.

### DETAILED DESCRIPTION

The depth calculating methods of the exemplary embodiments adopt several motion vector correction techniques to adjust motion vectors corresponding to input frame data, and generate depth data according to motion parallax data corresponding to the motion vectors.

### First Embodiment

The depth calculating method of this embodiment adopts the region motion vector correction technique and the technique of correcting the motion vector of the target macroblock with reference to the neighboring macroblock motion vectors to correct the motion vector corresponding to the input frame data, and estimates the depth data corresponding to the input frame data with the motion parallax data corresponding to the corrected motion vector serving as a clue.

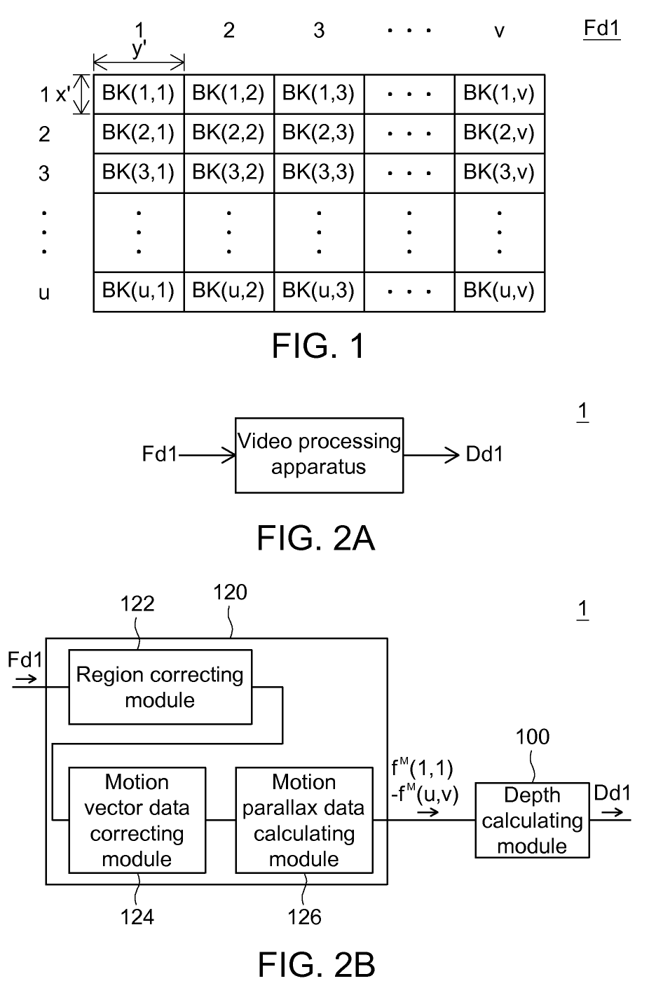

FIG. 1 is a schematic illustration showing frame data Fd1. FIGS. 2A and 2B are block diagrams showing a depth calculating apparatus 1 according to a first exemplary embodiment of the disclosure. Referring to FIGS. 1, 2A, and 2B, the depth calculating apparatus 1 receives the frame data Fd1 of input video data Vdi, and calculates depth data Dd1 corresponding to the frame data Fd1. The depth data Dd1 includes multiple pieces of macroblock depth data respectively corresponding to multiple macroblocks in the frame data Fd1.

For example, the frame data Fd1 includes x×y pieces of pixel data, which are divided into u×v macroblocks BK(1,1), BK(1,2), . . . , BK(1,v), BK(2,1), . . . , BK(2,v), . . . , BK(u,v). Each of the macroblocks BK(1,1) to BK(u,v) includes x′×y′ pieces of pixel data, wherein x, y, u and v are natural numbers greater than 1, and x and y are respectively equal to the product of x′ and u and the product of y′ and v. For example, x′ and y′ are equal to 8. In this example, the depth data Dd1 includes u×v pieces of macroblock depth data.

The depth calculating apparatus 1 includes a motion parallax data module 120 and a depth calculating module 100. The motion parallax data module 120 generates u×v pieces of macroblock motion parallax data MP(1,1) to MP(u,v) according to the motion vector data corresponding to the u×v macroblocks BK(1,1) to BK(u,v). The motion parallax data module 120 includes a region correcting module 122 and a motion vector data correcting module 124 for correcting the motion vector data of the macroblocks BK(1,1) to BK(u,v).

The region correcting module 122 finds smooth macroblocks in the macroblocks BK(1,1) to BK(u,v). For example, the region correcting module 122 determines whether the to-be-detected macroblock DBK is a smooth macroblock according to the condition that whether the MAD mean MADB of M mean absolute differences MAD1 to MADM of the to-be-detected macroblock DBK is smaller than a MAD threshold value. The M mean absolute differences MAD1 to MADM of the to-be-detected macroblock DBK are calculated between the to-be-detected macroblock DBK itself and the M reference macroblocks RBK1 to RBKM of the to-be-detected macroblock DBK (RBK1 to RBKM are determined by the motion vector data of the surrounding macroblocks of DBK). The region correcting module 122 generates the MADB of MAD1 to MADM according to the operations that may be expressed by the following equations:

$$MADi = \frac{1}{{x}^{′} \times {y}^{′}} {\sum }_{X = 1}^{{x}^{′}} {\sum }_{Y = 1}^{{y}^{′}} \vert {I}_{DBK} ( X , Y ) - {I}_{RBKi} ( X , Y ) \vert \vert i = 1 , 2 , … , M$$

$$MADB = \frac{1}{M} {\sum }_{i = 1}^{M} MADi$$

wherein X and Y are coordinate values of the x′×y′ pieces of pixel data in the macroblock, I_{DBK}(X,Y) is the pixel data having the coordinate value (X,Y) in the to-be-detected macroblock DBK, and I_{RBKi}(X,Y) is the pixel data corresponding to the same position (X,Y) of the pixel data I_{DBK}(X,Y) in the reference macroblock RBKi.

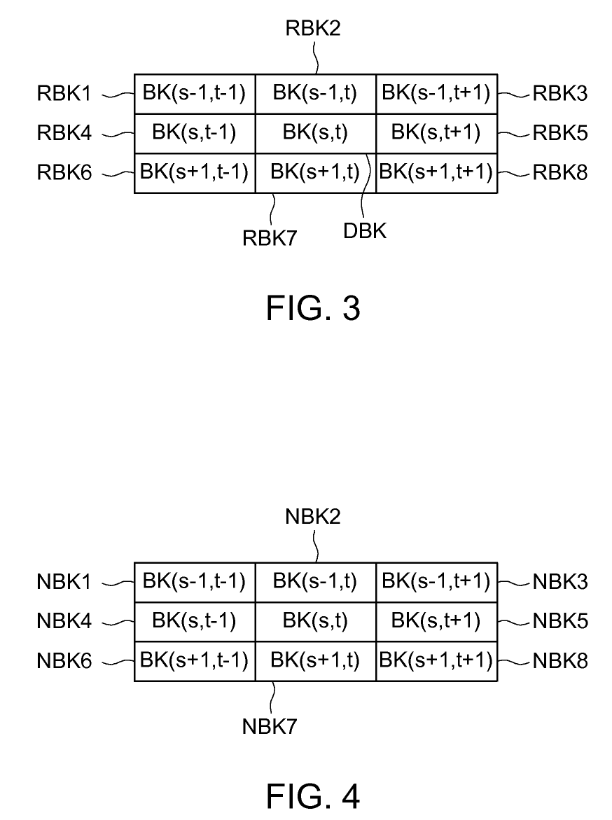

For example, M is equal to 8, and the reference macroblocks RBK1 to RBK8 are eight neighboring macroblocks respectively located on the upper left side, the upper side, the upper right side, the left side, the right side, the lower left side, the lower side and the lower right side around the to-be-tested macroblock, as shown in FIG. 3.

When the MAD mean MADB corresponding to the to-be-tested macroblock DBK is smaller than the MAD threshold value, the region correcting module 122 judges the to-be-tested macroblock DBK as a smooth macroblock and adjusts the motion vector data corresponding to the to-be-tested macroblock DBK as a zero motion vector. When the MAD mean MADB corresponding to the to-be-tested macroblock DBK is greater than or equal to the MAD threshold value, the region correcting module 122 judges the to-be-tested macroblock DBK as not being a smooth macroblock, and reserves the motion vector data of the to-be-tested macroblock DBK.

The motion vector data correcting module 124 finds N neighboring macroblocks NBK1 to NBKN with respect to each of the macroblocks BK(1,1) to BK(u,v), and sets the motion vector data of each of the macroblocks BK(1,1) to BK(u,v) to be equal to the mean motion vector data of the neighboring macroblocks NBK1 to NBKN. For example, N is equal to 8, and the neighboring macroblocks NBK1 to NBK8 are eight neighboring macroblocks respectively located on the upper left side, the upper side, the upper right side, the left side, the right side, the lower left side, the lower side and the lower right side around each of the macroblocks BK(1,1) to BK(u,v), as shown in FIG. 4.

A motion parallax data calculating module 126 generates macroblock motion parallax data f^{M}(1,1) to f^{M}(u,v) according to the macroblock motion vector data corrected by the region correcting module 122 and the motion vector data correcting module 124. For example, the macroblock motion parallax data f^{M}(U,V) satisfies the equation:

$${f}^{M} ( U , V ) = \sqrt{\begin{matrix}{MV ( U , V )}_{h}^{2} + \\ {MV ( U , V )}_{v}^{2}\end{matrix}} \vert U = 1 , 2 , … , u ; V = 1 , 2 , … , v$$

wherein MV(U,V)ₕ is a horizontal motion vector corresponding to the macroblock BK(U,V), and MV(U,V)ᵥ is a vertical motion vector corresponding to the macroblock BK(U,V).

In one example, the motion parallax data calculating module 126 further normalizes the macroblock motion parallax data f^{M}(1,1) to f^{M}(u,v) into the values 0 to 255, and a median filter and a Gaussian filter are adopted to smooth the macroblock motion parallax data f^{M}(1,1) to f^{M}(u,v).

For example, when the normalized macroblock motion parallax data f^{M}(1,1) to f^{M}(u,v) have the low values (e.g., approximating the value 0), it represents that the corresponding motion parallax is small while the corresponding depth is large. When the normalized macroblock motion parallax data f^{M}(1,1) to f^{M}(u,v) have the high values (e.g., approximating the value 255), it represents that the corresponding motion parallax is large while the corresponding depth is small. Accordingly, the depth calculating module 100 determines the depth data Dd1 including the u×v pieces of macroblock depth data as corresponding to the macroblocks BK(1,1) to BK(u,v) in the frame data Fd1 according to the macroblock motion parallax data f^{M}(1,1) to f^{M}(u,v) provided by the motion parallax data calculating module 126. The value of each piece of the macroblock depth data in the depth data Dd1 also ranges from, for example, 0 to 255, which respectively indicates the depth data corresponding to the large depth to the small depth.

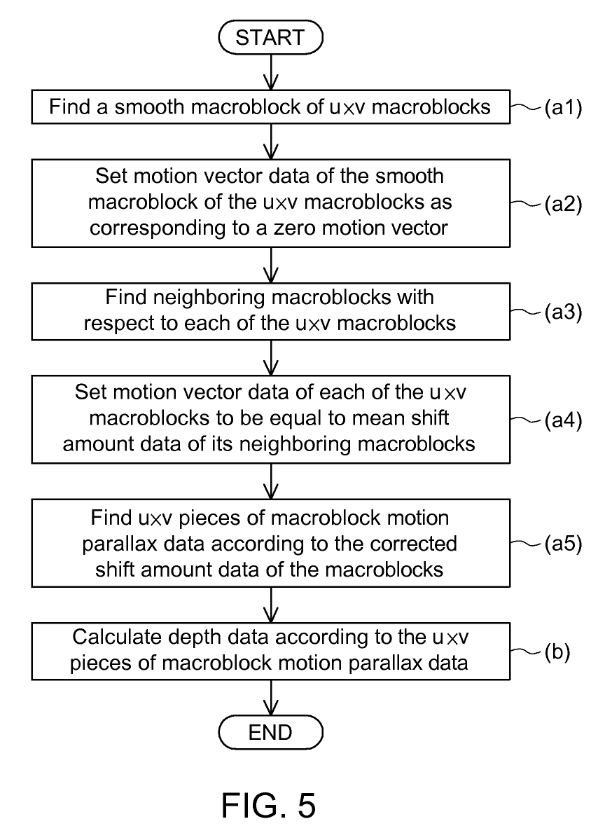

FIG. 5 is a flow chart showing a depth calculating method according to the exemplary embodiment of the disclosure. As shown in FIG. 5, the steps of the depth calculating method of this exemplary embodiment have been described hereinabove, so detailed descriptions thereof will be omitted.

In this exemplary embodiment, the motion parallax data calculating module 126 further has a shot change detecting module (not shown) for detecting the frame data of the input video data Vdi with the shot change, and for performing a shot change detection on the motion vector data corresponding to the frame data. The motion parallax data calculating module 126 may generate the macroblock motion parallax data f^{M}(1,1) to f^{M}(u,v) according to the motion vector data corrected by the shot change detecting module.

For example, the shot change detecting module performs a histogram operation on each of the pieces of frame data of the input video data Vdi, such that 256 pixel amounts corresponding to the respective 256 gray levels (0 to 255) of each piece of frame data of the input video data Vdi are obtained. The shot change detecting module further obtains 256 pixel data amount differences corresponding to each piece of frame data of the input video data Vdi by comparing the histogram result of each piece of frame data and its previous piece of frame data in the input video data Vdi. The shot change detecting module further obtains a summed difference corresponding to each piece of frame data of the input video data Vdi by summing the corresponding 256 pixel data amount differences and judges whether the summed difference is greater than a threshold value. If not, it is judged that the shot change event does not occur between the piece of frame data and its previous piece of frame data.

If it is judged that the summed difference is greater than a threshold value, the shot change detecting module calculates another set of motion vector data to correct the corresponding motion vector data. For example, the set of motion data are calculated based on the frame data and the next N pieces of frame data of the frame data, wherein N is a natural number.

In this exemplary embodiment, the motion parallax data calculating module 126 further includes, for example, a motion refinement module (not shown) for performing the motion refinement on the motion vector data corresponding to each frame data of the input video data Vdi with reference to camera motion data. The motion parallax data calculating module 126 may generate the macroblock motion parallax data f^{M}(1,1) to f^{M}(u,v) according to the motion vector data corrected by the motion refinement module.

In one example, the input video data Vdi is the video data obtained through the MPEG-2 or MPEG-4 standard decompression, while the motion parallax data module 120 may further generate the motion vector data with reference to corresponding motion vector information in the MPEG-2 or MPEG-4 standard to obtain the corresponding macroblock motion parallax data f^{M}(1,1) to f^{M}(u,v).

The depth calculating method of this exemplary embodiment adopts the region motion vector correction technique to generate the depth data with reference to the motion vector of the neighboring macroblock motion vector corresponding to the input frame data and according to the macroblock motion parallax data corresponding to the motion vector. Thus, compared with the conventional depth data generating method, the depth calculating method of this exemplary embodiment has the advantage of enhancing the precision of the depth data.

### Second Embodiment

The depth calculating method of this exemplary embodiment generates the depth data with reference to the motion parallax data and further to a portion of parameter data or the entire parameter data associated with the atmospheric perspective and the texture gradient.

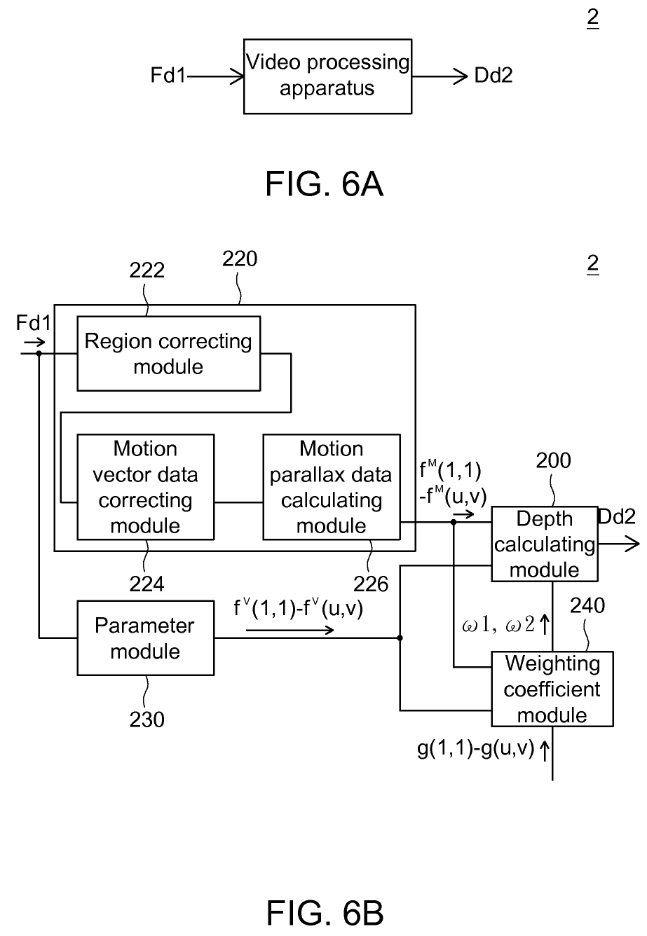

FIGS. 6A and 6B are block diagrams showing a depth calculating apparatus 2 according to a second exemplary embodiment of the disclosure. The difference between the depth calculating apparatus 2 of the second exemplary embodiment and the depth calculating apparatus of the first exemplary embodiment is that the depth calculating apparatus 2 further includes a parameter module 230 for providing another set of parameter data to a depth calculating module 200 with respect to each of the macroblocks BK(1,1) to BK(u,v). The depth calculating module 200 calculates a sum of the macroblock motion parallax data f^{M}(1,1) to f^{M}(u,v) and the another set of parameter data corresponding to the same macroblock according to weighting coefficients ω1 and ω2 to obtain the depth data Dd2.

In one example, the another set of parameter data relates to the parameter data of atmospheric perspective. Generally speaking, suspended particles in the air make the shot video data, corresponding to the object at the shorter distance, have the frame characteristic of the sharp edge information, and make the shot video data, corresponding to the object at the longer distance, have the frame characteristic of the blurred edge information. Consequently, the parameter module 230 in this example analyzes the macroblock variance data of the frame data Fd1 corresponding to each of the macroblocks BK(l,1) to BK(u,v) and thus provides the data of the frame edge sharpness information as the clue for depth estimation. The depth calculating module 200 generates the depth data Dd2 with reference to the macroblock variance data f^{V}(1,1) to f^{V}(u,v) and the macroblock motion parallax data f^{M}(1,1) to f^{M}(u,v).

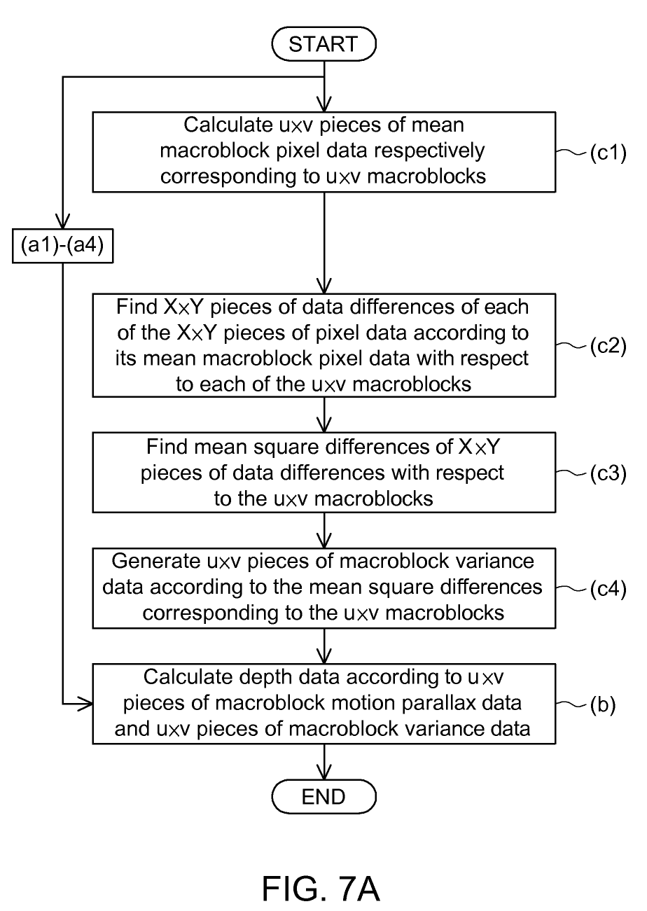

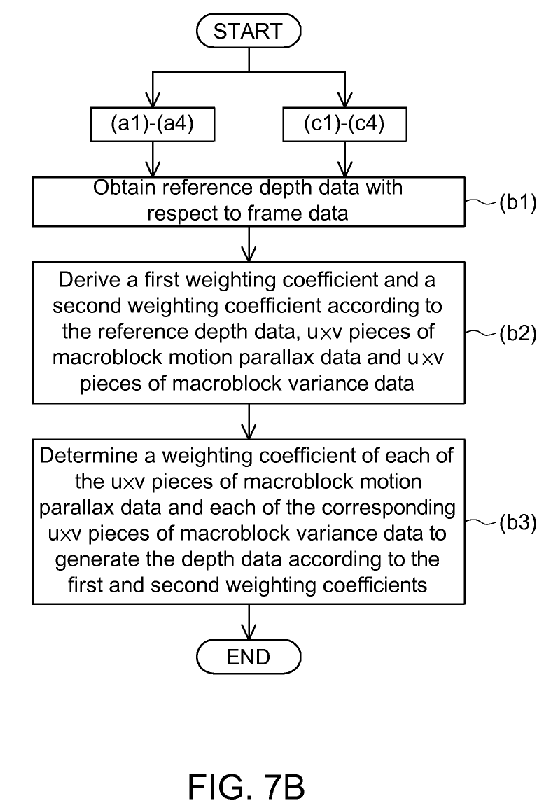

For example, the parameter module 230 calculates the macroblock variance data f^{V}(1,1) to f^{V}(u,v) according to the steps of FIG. 7A. First, as shown in step (c1), the parameter module 230 calculates u×v pieces of mean macroblock pixel data respectively corresponding to the macroblocks BK(1,1) to BK(u,v). Next, as shown in step (c2), the parameter module 230 finds x′×y′ pieces of data differences of each of the x′×y′ pieces of pixel data according to its mean macroblock pixel data with respect to each of the macroblocks BK(1,1) to BK(u,v).

Then, as shown in step (c3), the parameter module 230 finds mean square differences of the x′×y′ pieces of data differences with respect to the macroblocks BK(1,1) to BK(u,v). Thereafter, as shown in step (c4), u×v pieces of macroblock variance data f^{V}(1,1) to f^{V}(u,v) are generated according to the mean square pixel differences corresponding to the macroblocks BK(1,1) to BK(u,v).

For example, the step operation may be represented by the following equation:

$${f}^{v} ( U , V ) = \frac{1}{{x}^{′} \times {y}^{′} - 1} {\sum }_{X = 1}^{{x}^{′}} {\sum }_{Y = 1}^{{y}^{′}} {[ \begin{matrix}{I}_{BK ( U , V )} ( X , Y ) - \\ {IB}_{BK ( U , V )}\end{matrix} ]}^{2} \vert U = 1 , 2 , … , u ; V = 1 , 2 , … , v$$

wherein f^{V}(U,V) is the macroblock variance data corresponding to the macroblock BK(U,V), I_{BK(U,V)}(X,Y) is the pixel data with the coordinates (X,Y) in the macroblock BK(U,V), IB_{BK}(U,V) is the mean square difference of the x′×y′ pieces of pixel data in the macroblock BK(U,V).

The parameter module 230 further normalizes the macroblock variance data f^{V}(1,1) to f^{V}(u,v) into 0 to 255, and adopts the median filter and the Gaussian filter to smooth the macroblock variance data.

For example, when the normalized macroblock variance data f^{V}(1,1) to f^{V}(u,v) have the low values (e.g., approximating the value 0), it represents that the corresponding image variance is small, the edge sharpness information is low and the corresponding depth is large. When the normalized macroblock variance data f^{V}(1,1) to f^{V}(u,v) have the high values (e.g., approximating the value 255), it represents that the corresponding image variance is large, the edge sharpness information is high and the corresponding depth is small.

The depth calculating module 200 generates the u×v pieces of macroblock depth data Dd2(1,1) to Dd2(u,v) in the depth data Dd2 according to the macroblock motion parallax data f^{M}(1,1) to f^{M}(u,v), macroblock variance data f^{V}(1,1) to f^{V}(u,v) and the weighting coefficients φ1 and φ2 and according to the following equation:

$$( \begin{matrix}{f}^{M} ( 1 , 1 ) & {f}^{V} ( 1 , 1 ) \\ {f}^{M} ( 1 , 2 ) & {f}^{V} ( 1 , 2 ) \\ ⋮ & ⋮ \\ {f}^{M} ( 1 , v ) & {f}^{V} ( 1 , v ) \\ ⋮ & ⋮ \\ {f}^{M} ( u , v ) & {f}^{V} ( u , v )\end{matrix} ) \times ( \begin{matrix}ω 1 \\ ω2\end{matrix} ) = ( \begin{matrix}Dd 2 ( 1 , 1 ) \\ Dd 2 ( 1 , 2 ) \\ ⋮ \\ Dd 2 ( 1 , v ) \\ ⋮ \\ Dd 2 ( u , v )\end{matrix} )$$

In one example, the depth calculating apparatus 2 further includes a weighting coefficient module 240 for deriving the weighting coefficients φ1 and φ2 according to true depth values g(1,1) to g(u,v), the macroblock variance data f^{V}(1,1) to f^{V}(u,v) and the macroblock motion parallax data f^{M}(1,1) to f^{M}(u,v). For example, the true depth values g(1,1) to g(u,v) are the true depth results shot by the depth camera. The weighting coefficient module 240 obtains the better solutions of the weighting coefficients φ1 and φ2 through a pseudo-inverse matrix. Thus, the depth calculating module 200 may generate the better solution of the depth data Dd2 according to the macroblock variance data f^{V}(1,1) to f^{V}(u,v) and the macroblock motion parallax data f^{M}(1,1) to f^{M}(u,v).

For example, the weighting coefficient module 240 generates the weighting coefficients φ1 and φ2 according to the following equation:

$$( \begin{matrix}{f}^{M} ( 1 , 1 ) & {f}^{v} ( 1 , 1 ) \\ {f}^{M} ( 1 , 2 ) & {f}^{v} ( 1 , 2 ) \\ ⋮ & ⋮ \\ {f}^{M} ( 1 , v ) & {f}^{v} ( 1 , v ) \\ ⋮ & ⋮ \\ {f}^{M} ( u , v ) & {f}^{v} ( u , v )\end{matrix} ) \times ( \begin{matrix}ω 1 \\ ω2\end{matrix} ) = ( \begin{matrix}g ( 1 , 1 ) \\ g ( 1 , 2 ) \\ ⋮ \\ g ( 1 , v ) \\ ⋮ \\ g ( u , v )\end{matrix} )$$

FIG. 7B is a partial flow chart showing the depth calculating method according to the exemplary embodiment of the disclosure. The steps of the depth calculating method of this exemplary embodiment have been described hereinabove, so detailed descriptions thereof will be omitted.

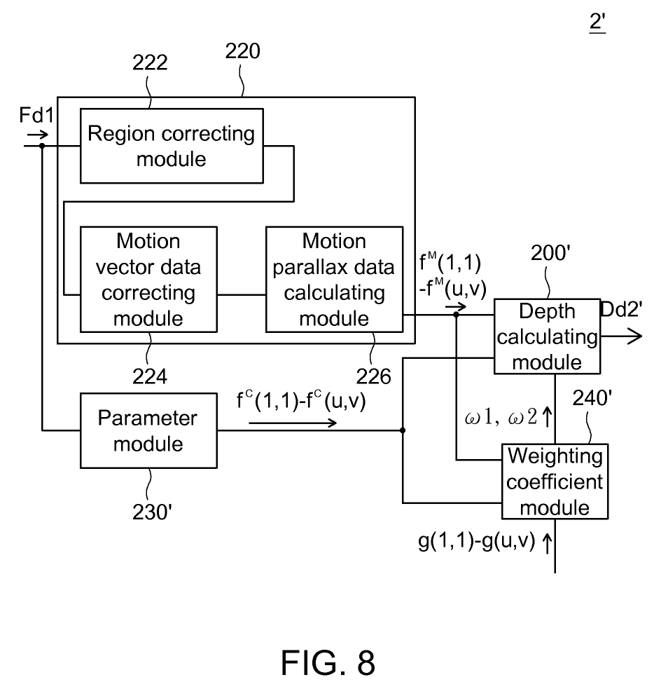

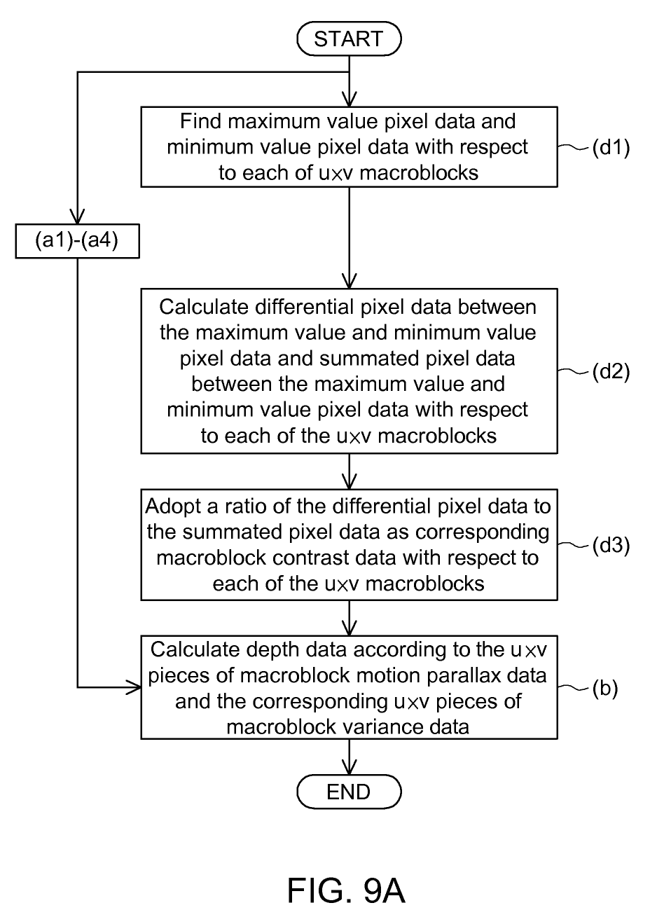

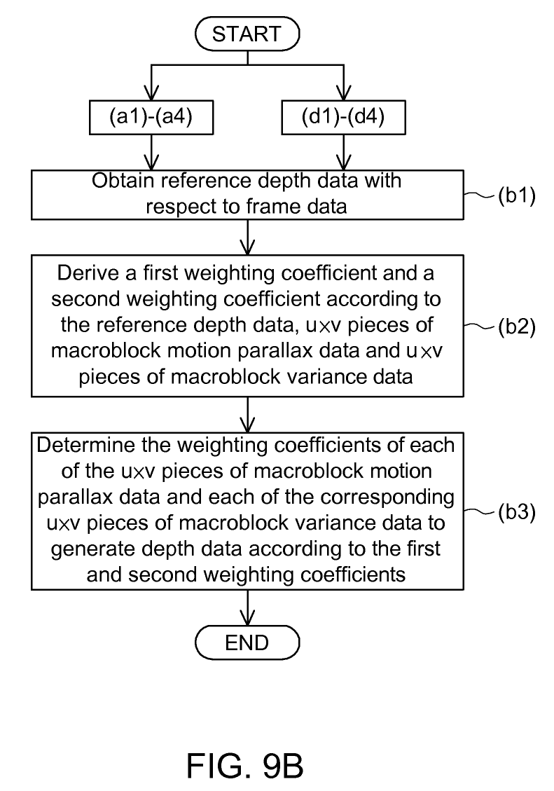

Although only the condition that the parameter module 230 obtains the parameter data associated with the atmospheric perspective by calculating the macroblock variance data f^{V}(1,1) to f^{V}(u,v) is illustrated as an example in this exemplary embodiment, the parameter module 230 of this exemplary embodiment is not limited thereto. In another example, the parameter module 230 may also generate the data associated with the atmospheric perspective parameter data by calculating the macroblock contrast data, as shown in FIGS. 8, 9A and 9B.

In this example, the parameter module 230′ generates the macroblock contrast data f^{C}(1,1) to f^{C}(u,v) corresponding to each of the macroblocks BK(1,1) to BK(u,v) through the following equation:

$${f}^{C} ( U , V ) = \frac{{I}_{MA X} ( U , V ) - {I}_{MI N} ( U , V )}{{I}_{MA X} ( U , V ) + {I}_{MI N} ( U , V )} \vert U = 1 , 2 , … , u ; V = 1 , 2 , … , v$$

wherein I_{MAX}(U,V) is the pixel data having the maximum pixel data value in the macroblock BK(U,V), and I_{MIN}(U,V) is the pixel data having the minimum pixel data value in the macroblock BK(U,V). For example, the parameter module 230′ further normalizes the macroblock contrast data f^{C}(1,1) to f^{C}(u,v) into 0 to 255, and smoothes the macroblock contrast data using the median filter and the Gaussian filter.

For example, when the normalized macroblock contrast data f^{C}(1,1) to f^{C}(u,v) have the low values (e.g., approximating the value 0), it means that the corresponding image contrast is low, the edge sharpness information is low and the corresponding depth is large. When the normalized macroblock contrast data f^{C}(1,1) to f^{C}(u,v) have the high values (e.g., approximating value 255), it means that the corresponding image contrast is high, the edge sharpness information is high and the corresponding depth is small.

The weighting coefficient module 240′ and the depth calculating module 200′ generate the weighting coefficients φ1 and φ2 as well as the depth data Dd2′ according to the operations substantially the same as the operations of the weighting coefficient module 240 and the depth calculating module 200.

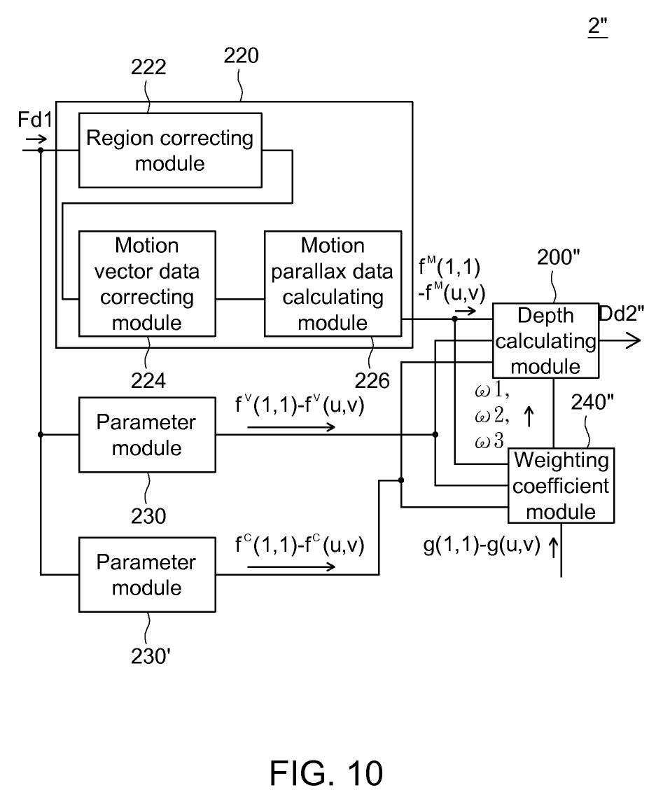

In this exemplary embodiment, only the condition that the depth calculating apparatus 2 includes one parameter module 230 or 230′ for generating another set of parameter data is illustrated as an example. However, the depth calculating apparatus 2 of this exemplary embodiment is not limited thereto. In another example, the depth calculating apparatus 2″ simultaneously includes two parameter modules 230 and 230′ for correspondingly providing two sets of atmospheric perspective parameter data (macroblock contrast data f^{C}(1,1) to f^{C}(u,v) and macroblock variance data f^{V}(1,1) to f^{V}(u,v)), as shown in FIG. 10.

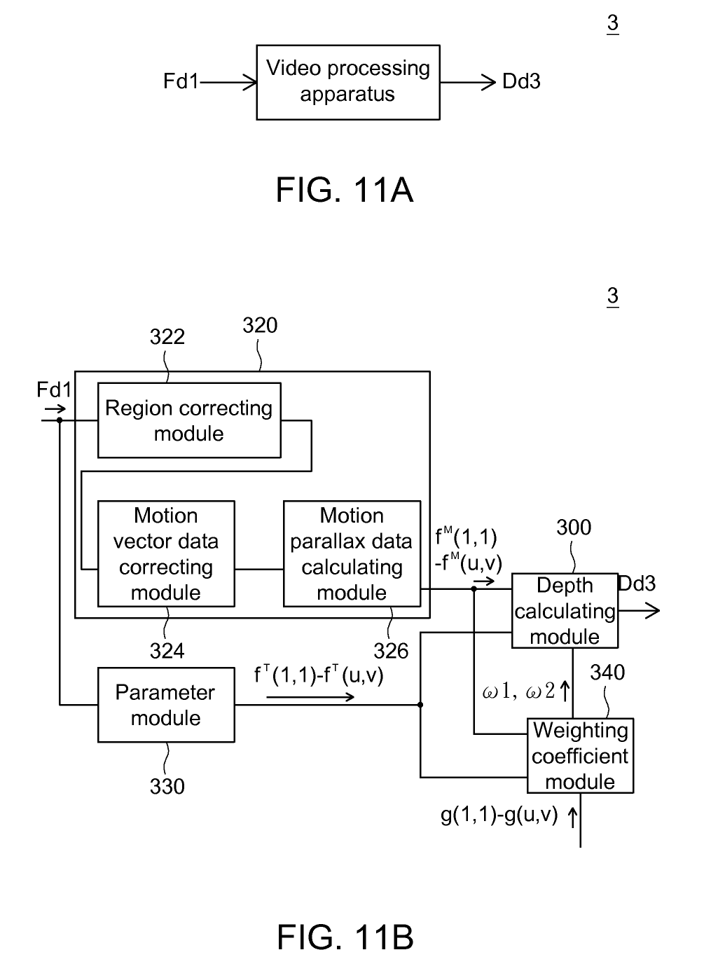

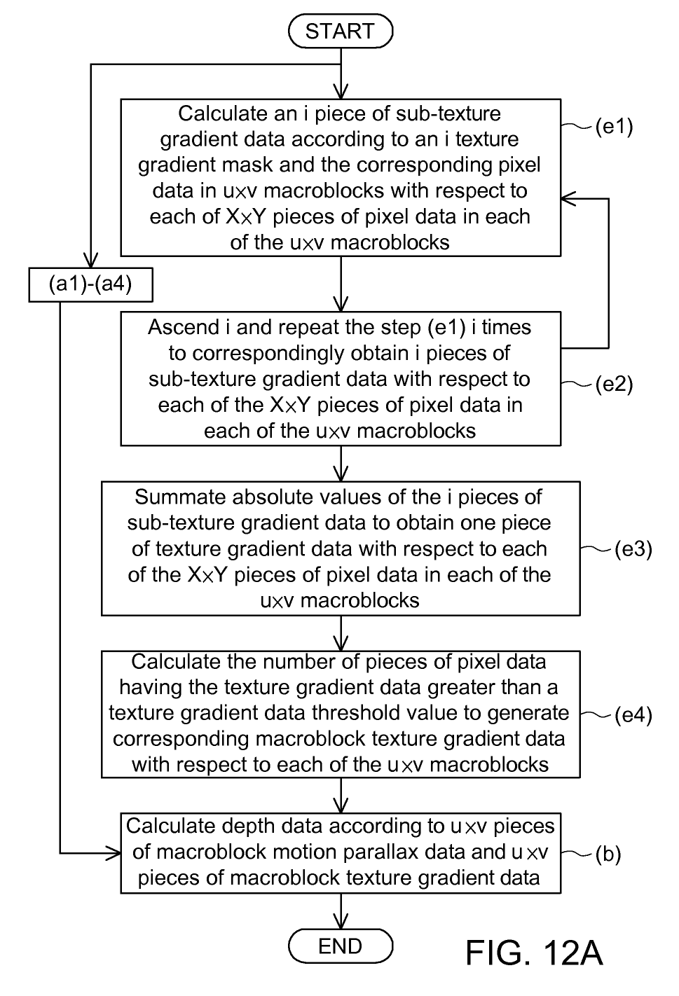

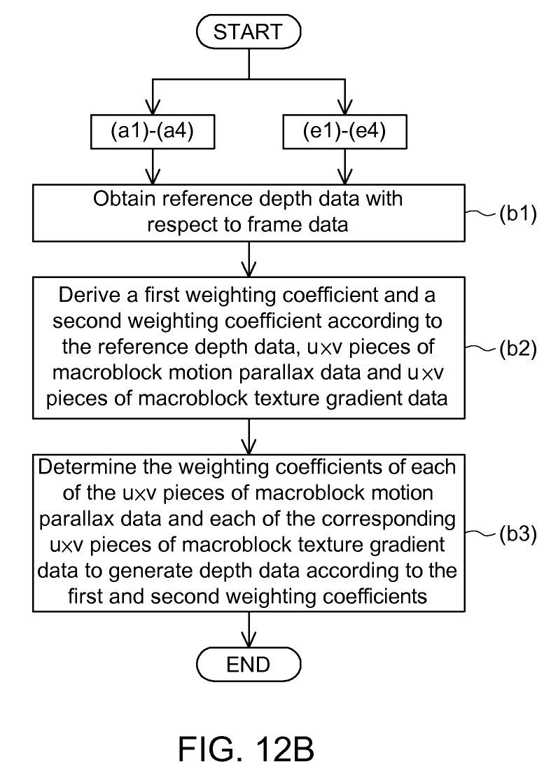

In this exemplary embodiment, only the condition that the depth calculating apparatus 2 calculates the depth data according to another set of atmospheric perspective parameter data is described as an example. However, the depth calculating apparatus of this exemplary embodiment is not limited thereto. In another example, a depth calculating apparatus 3 adopts another parameter module 330 to generate another set of parameter data associated with the texture gradient of the frame data Fd1 according to the frame data Fd1, as shown in FIGS. 11A, 11B, 12A and 12B.

Generally speaking, when the distance between the object and the camera in the image data is increased, the texture of the object is correspondingly changed from clear to blur. Consequently, the parameter module 330 generates the macroblock texture gradient data f^{T}(1,1) to f^{T}(u,v) respectively corresponding to the macroblocks BK(1,1) to BK(u,v) by analyzing the intensity of the texture energy in the image. Therefore, a depth calculating module 300 may adopt the macroblock texture gradient data as the clue to perform the depth estimation on the frame data Fdi.

For example, the parameter module 330 fits eight 3×3 Law's mask L3E3, L3S3, E3L3, E3E3, E3S3, S3L3, S3E3 and S3S3 with each of 64 pieces of pixel data in each of the macroblocks BK(1,1) to BK(u,v) to generate eight pieces of sub-texture gradient data with respect to each piece of pixel data.

The schematic illustrations of the 8 Law's masks respectively satisfy the following matrix:

$$L 3 E 3 = ( \begin{matrix}- 1 & 0 & 1 \\ - 2 & 0 & 2 \\ - 1 & 0 & 1\end{matrix} ) ; L 3 S 3 = ( \begin{matrix}- 1 & 2 & - 1 \\ - 2 & 4 & - 2 \\ - 1 & 2 & - 1\end{matrix} ) ;$$

$$E 3 L 3 = ( \begin{matrix}- 1 & - 2 & - 1 \\ 0 & 0 & 0 \\ 1 & 2 & 1\end{matrix} ) ; E 3 E 3 = ( \begin{matrix}1 & 0 & - 1 \\ 0 & 0 & 0 \\ - 1 & 0 & 1\end{matrix} ) ;$$

$$E 3 S 3 = ( \begin{matrix}1 & - 2 & 1 \\ 0 & 0 & 0 \\ - 1 & 2 & - 1\end{matrix} ) ;$$

$$S 3 L 3 = ( \begin{matrix}- 1 & - 2 & - 1 \\ 2 & 4 & 2 \\ - 1 & - 2 & - 1\end{matrix} ) ; S 3 E 3 = ( \begin{matrix}1 & 0 & - 1 \\ - 2 & 0 & 2 \\ 1 & 0 & - 1\end{matrix} ) ;$$

$$S 3 S 3 = ( \begin{matrix}1 & - 2 & 1 \\ - 2 & 4 & - 2 \\ 1 & - 2 & 1\end{matrix} )$$

The parameter module 330 further accumulates the eight pieces of sub-texture gradient data to obtain one piece of texture gradient data with respect to each piece of pixel data. The parameter module 330 further calculates the number of pieces of pixel data having the texture gradient data greater than a texture gradient data threshold value in each macroblock with respect to the macroblocks BK(1,1) to BK(u,v), respectively, to generate the corresponding macroblock texture gradient data f^{T}(1,1) to f^{T}(u,v). For example, the operation of the parameter module 330 may be expressed by the following equations:

$${f}_{i}^{T} ( X , Y ) = \vert {\sum }_{s = - 1}^{1} {\sum }_{t = - 1}^{1} {w}_{i} ( s , t ) \times I ( X + s , Y + t ) \vert \vert i = 1 , 2 , … , 8 ; X = 1 , 2 , … , x ; Y = 1 , 2 , … , y$$

$${f}^{T} ( U , V ) = {\sum }_{X = {x}^{′} \times ( U - 1 )}^{{x}^{′} \times U} {\sum }_{Y = {y}^{′} \times ( V - 1 )}^{{y}^{′} \times V} U ( {\sum }_{i = 1}^{8} \vert {f}_{i}^{T} ( X , Y ) \vert - Td 1 ) \vert U = 1 , 2 , … , u ; V = 1 , 2 , … , v$$

wherein fᵢ^{T}(X,Y) is the i^{th} piece of sub-texture gradient data corresponding to the pixel data I(X,Y); wᵢ(s,t) is the mask parameter at the position (s,t) in the i^{th} Law's mask; I(X+s,Y+t) is the pixel data, on which the filter operation is performed through the Law's mask when the texture gradient data fᵢ^{T}(X,Y) corresponding to the pixel data I(X,Y) is being calculated, and Td1 is the texture gradient data threshold value. The

$$U ( {\sum }_{i = 1}^{8} \vert {f}_{i}^{T} ( X , Y ) \vert - Td 1 )$$

s a unit step function. When the texture gradient data (obtained by accumulating corresponding eight pieces of sub-texture gradient data) corresponding to one piece of pixel data is greater than the texture gradient data threshold value, it means that this piece of pixel data has the high texture gradient energy, and the unit step function has the value of 1. When the texture gradient data corresponding to this piece of pixel data is smaller than or equal to the texture gradient data threshold value, it means that this piece of pixel data has the low texture gradient energy, and the unit step function has the value of 0. Thereafter, accumulating the unit step function values corresponding to the same macroblock can obtain the number of pieces of pixel data having the corresponding texture gradient data greater than the texture gradient data threshold value in the 64 pieces of pixel data of the macroblock, so that the corresponding macroblock texture gradient data may be generated.

For example, the parameter module 330 further normalizes the u×v pieces of macroblock texture gradient data f^{T}(1,1) to f^{T}(u,v) into 0 to 255, and smoothes the u×v pieces of macroblock texture gradient data using the median filter and the Gaussian filter.

For example, when the normalized macroblock texture gradient data f^{T}(1,1) to f^{T}(u,v) have the low values (e.g., approximating the value 0), it means that the texture gradient energy corresponding to the image is low and the corresponding depth is large. When the normalized macroblock texture gradient data f^{T}(1,1) to f^{T}(u,v) have the high values (e.g., approximating the value 255), it represents that the texture gradient energy corresponding to the image is high and the corresponding depth is small.

Thereafter, similar to the depth calculating module 200, the depth calculating module 300 generates the depth data Dd3 according to the weighting coefficients φ1 and φ2 and the macroblock motion parallax data f^{M}(1,1) to f^{M}(u,v) and the macroblock texture gradient data f^{T}(1,1) to f^{T}(u,v) corresponding to the same macroblock.

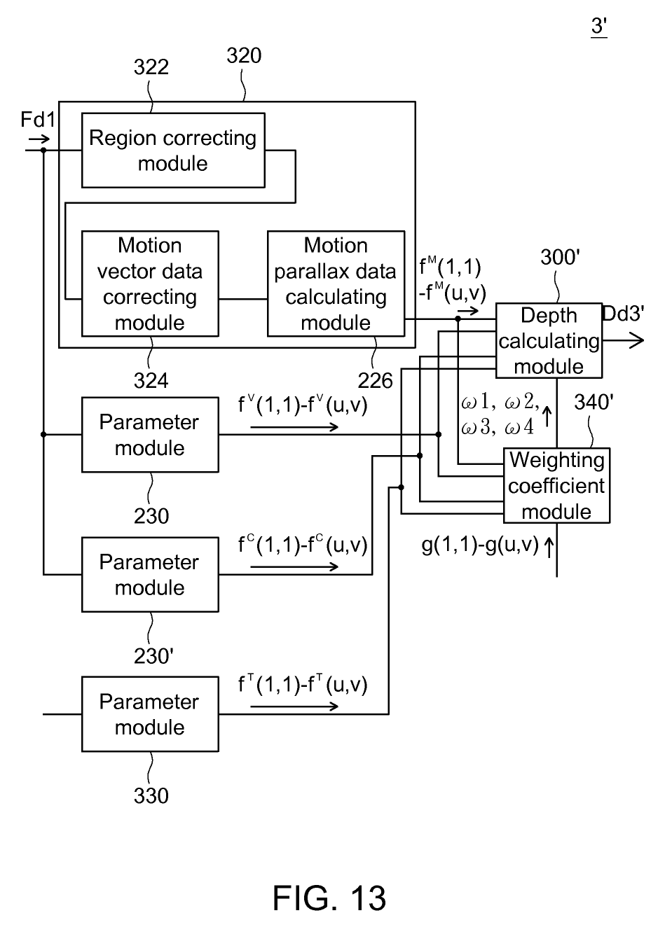

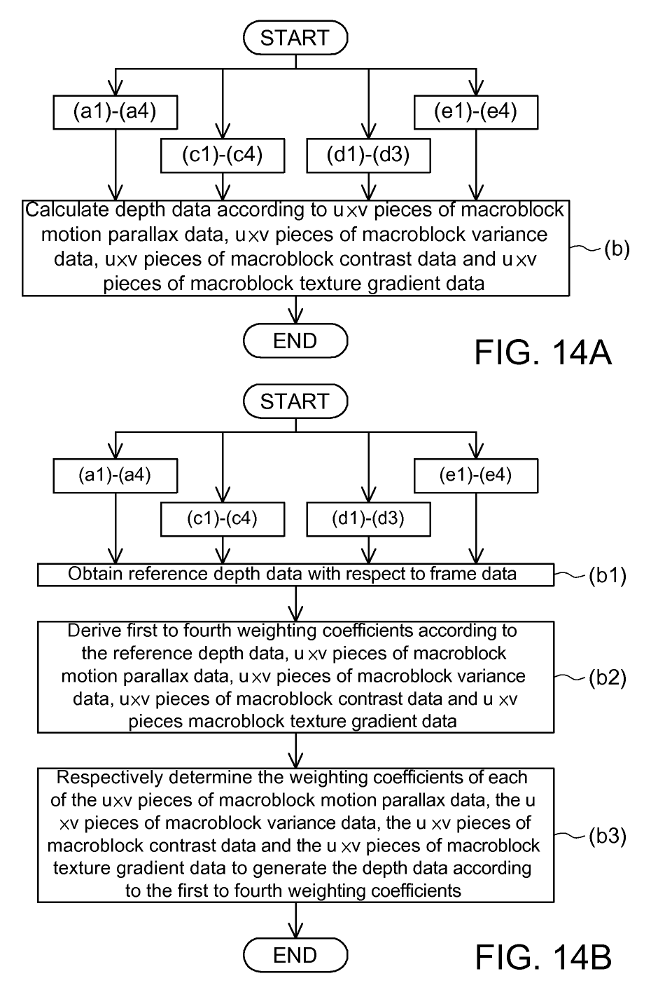

In another example, as shown in FIGS. 13, 14A and 14B, the depth calculating apparatus 3′ includes three parameter modules 230, 230′ and 330 to correspondingly generate the macroblock variance data f^{V}(1,1) to f^{V}(u,v), the macroblock contrast data f^{C}(1,1) to f^{C}(u,v) and the macroblock texture gradient data f^{T}(1,1) to f^{T}(u,v). The weighting coefficient module 340′ in the depth calculating apparatus 3′ generates the weighting coefficients φ1, φ2, φ3 and φ4 according to the following equation:

$$( \begin{matrix}{f}^{M} ( 1 , 1 ) & {f}^{v} ( 1 , 1 ) & {f}^{C} ( 1 , 1 ) & {f}^{T} ( 1 , 1 ) \\ {f}^{M} ( 1 , 2 ) & {f}^{v} ( 1 , 2 ) & {f}^{C} ( 1 , 2 ) & {f}^{T} ( 1 , 2 ) \\ ⋮ & ⋮ & ⋮ & ⋮ \\ {f}^{M} ( 1 , v ) & {f}^{v} ( 1 , v ) & {f}^{C} ( 1 , v ) & {f}^{T} ( 1 , v ) \\ ⋮ & ⋮ & ⋮ & ⋮ \\ {f}^{M} ( u , v ) & {f}^{v} ( u , v ) & {f}^{C} ( u , v ) & {f}^{T} ( u , v )\end{matrix} ) \times ( \begin{matrix}ω 1 \\ ω 2 \\ ω 3 \\ ω 4\end{matrix} ) = ( \begin{matrix}g ( 1 , 1 ) \\ g ( 1 , 2 ) \\ ⋮ \\ g ( 1 , v ) \\ ⋮ \\ g ( u , v )\end{matrix} )$$

The depth calculating module 300′ may respectively determine the weighting coefficients of the macroblock motion parallax data f^{M}(1,1) to f^{M}(u,v), the macroblock variance data f^{V}(1,1) to f^{V}(u,v), the macroblock contrast data f^{C}(1,1) to f^{C}(u,v) and the macroblock texture gradient data f^{T}(1,1) to f^{T}(u,v) corresponding to the same macroblock according to the weighting coefficients φ1, φ2, φ3 and φ4, as listed in the following equation:

$$( \begin{matrix}{f}^{M} ( 1 , 1 ) & {f}^{v} ( 1 , 1 ) & {f}^{C} ( 1 , 1 ) & {f}^{T} ( 1 , 1 ) \\ {f}^{M} ( 1 , 2 ) & {f}^{v} ( 1 , 2 ) & {f}^{C} ( 1 , 2 ) & {f}^{T} ( 1 , 2 ) \\ ⋮ & ⋮ & ⋮ & ⋮ \\ {f}^{M} ( 1 , v ) & {f}^{v} ( 1 , v ) & {f}^{C} ( 1 , v ) & {f}^{T} ( 1 , v ) \\ ⋮ & ⋮ & ⋮ & ⋮ \\ {f}^{M} ( u , v ) & {f}^{v} ( u , v ) & {f}^{C} ( u , v ) & {f}^{T} ( u , v )\end{matrix} ) \times ( \begin{matrix}ω 1 \\ ω 2 \\ ω 3 \\ ω 4\end{matrix} ) = ( \begin{matrix}Dd {3}^{′} ( 1 , 1 ) \\ D d {3}^{′} ( 1 , 2 ) \\ ⋮ \\ Dd {3}^{′} ( 1 , v ) \\ ⋮ \\ Dd {3}^{′} ( u , v )\end{matrix} )$$

Different from the depth calculating method of the first exemplary embodiment, the depth calculating method generates the depth data with reference to the motion parallax data and further to a portion of parameter data or the entire parameter data associated with the atmospheric perspective and the texture gradient. Consequently, compared with the conventional depth data generating method, the depth calculating method of this embodiment has the advantage of enhancing the precision of the depth data.

### Third Embodiment

The depth calculating method of this exemplary embodiment classifies the input video data into several video types with reference to the motion activity of all the frame data of the input video data and the complicated level of the frame background. The depth calculating method adopts different calculating operations to obtain the depth data according to the input video data pertaining to different video types.

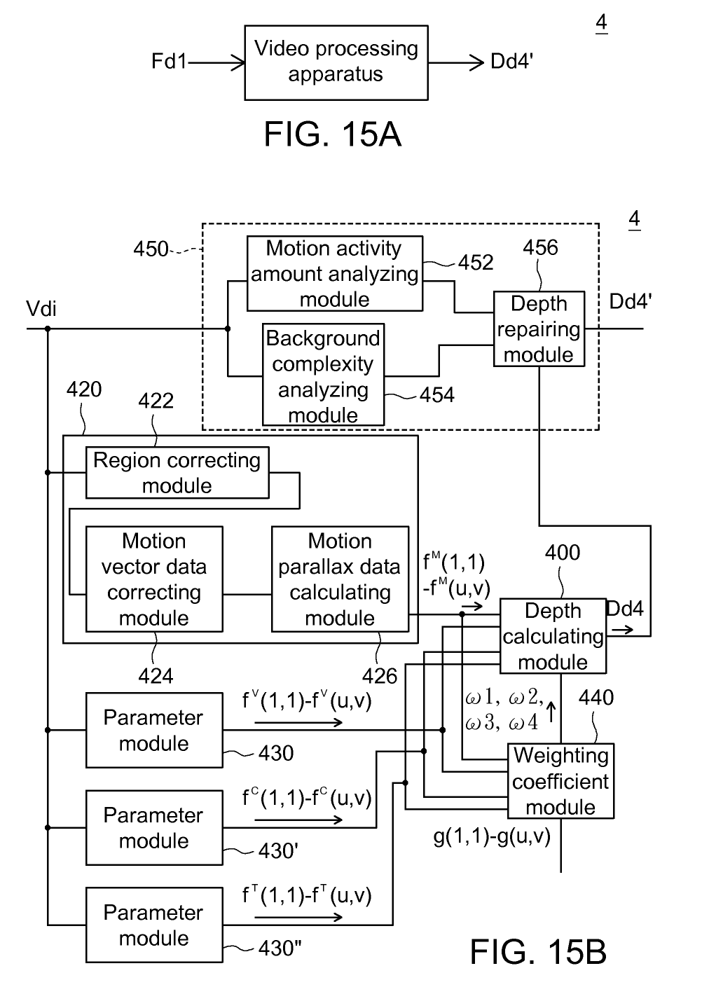

FIGS. 15A and 15B are block diagrams showing a depth calculating apparatus 4 according to a third exemplary embodiment of the disclosure. The difference between the depth calculating apparatus 4 of this exemplary embodiment and the depth calculating apparatus of the second exemplary embodiment is that the depth calculating apparatus 4 further includes a video classifying module 450. The video classifying module 450 judges that the input video data Vdi pertains to one of several video types according to all the J pieces of frame data in the input video data Vdi, wherein J is a natural number greater than 1. The video classifying module 450 further repairs the depth data Dd4 to generate the repaired depth data Dd4′ in response to the video type to which the input video data Vdi pertains.

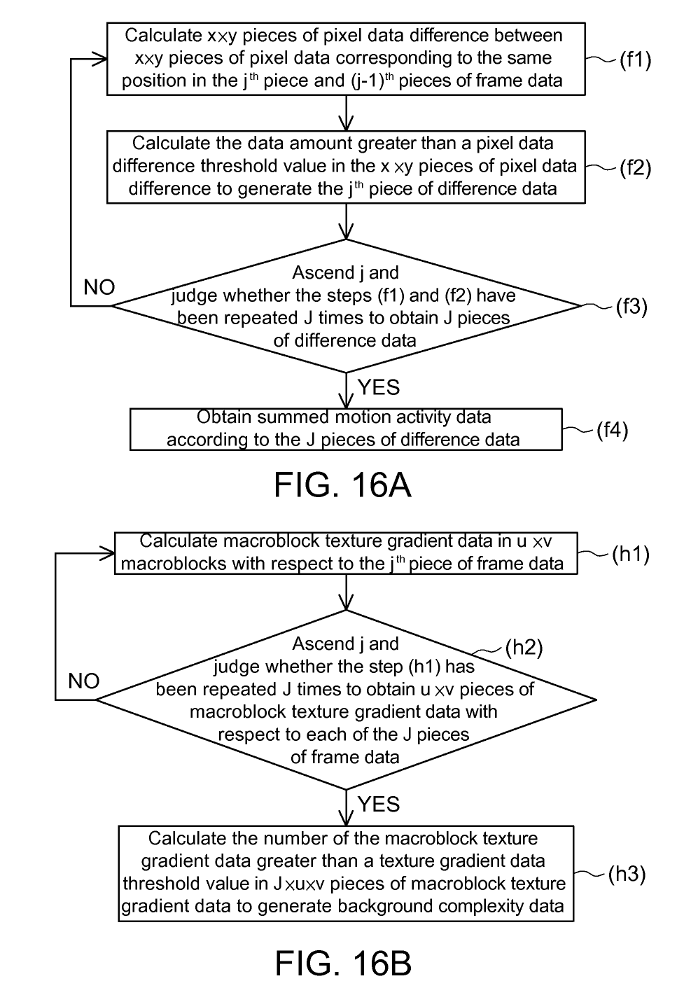

The video classifying module 450 includes a motion activity analyzing module 452, a background complexity analyzing module 454 and a depth repairing module 456. The motion activity analyzing module 452 calculates the summed motion activity data Smd of all the J pieces of frame data of the input video data Vdi. For example, the operation of the motion activity analyzing module 452 may be shown in the flow chart of FIG. 16A.

First, as shown in step (f1), the motion activity analyzing module 452 calculates the x×y pieces of pixel data differences between the x×y pieces of pixel data in the j^{th} piece of frame data of the J pieces of frame data and the x×y pieces of pixel data corresponding to the same position in the (j−1)^{th} pieces of frame data, wherein j is a natural number smaller than or equal to J, and the initial value of j is 1. Next, as shown in step (f2), the motion activity analyzing module 452 calculates the data amount greater than a pixel data difference threshold value in the x×y pieces of pixel data differences, and divides the data amount by the pixel data quantity (i.e., the value x′×y′) included in one piece of frame data to generate the j^{th} piece of difference data Smd(j). For example, the operations of steps (f1) and (f2) may be expressed by the following equation (Td2 is another threshold value):

$$Smdj = \frac{1}{{x}^{′} \times {y}^{′}} {{\sum }_{X}}^{{x}^{′}} {{\sum }_{Y}}^{{y}^{′}} U ( \vert I ( X , Y , j ) - I ( X , Y , j - 1 ) \vert - Td 2 )$$

Next, as shown in step (f3), the motion activity analyzing module 452 ascends j to repeat the steps (f1) and (f2) J times to correspondingly obtain J pieces of difference data Smd1 to SmdJ. Thereafter, as shown in step (f4), the motion activity analyzing module 452 multiplies the sum of the J pieces of difference data Smd1 to SmdJ by the coefficient 1/J to obtain the summed motion activity data Smd. For example, the operations of steps (f3) and (f4) may be expressed by the following equations:

$$Smd = \frac{1}{J} {\sum }_{j = 1}^{J} Smdj = \frac{1}{{x}^{′} \times {y}^{′} \times J} {\sum }_{j}^{J} {{\sum }_{X}}^{{x}^{′}} {\sum }_{Y}^{{y}^{′}} U ( \vert \begin{matrix}I ( X , Y , j ) - \\ I ( X , Y , j - 1 )\end{matrix} \vert - Td 2 )$$

The depth repairing module 456 judges whether the summed motion activity data Smd is greater than a summed motion activity data threshold value. If so, the depth repairing module 456 judges the input video data Vdi as pertaining to the video data with a high motion activity. If not, the depth repairing module 456 judges the input video data Vdi as pertaining to the video data with a low motion activity.

The background complexity analyzing module 454 calculates the background complexity data Bcd of the J pieces of frame data. In one example of the operation of calculating the background complexity data Bcd, the background complexity analyzing module 454 may selectively perform the calculation with reference to the entire video data in each piece of frame data or some regions (e.g., the upper half portion) of the video data in each of the J pieces of frame data.

For example, the operation performed by the background complexity analyzing module 454 is shown in FIG. 16B. First, as shown in step (h1), the background complexity analyzing module 454 calculates the macroblock texture gradient data f^{T}(1,1,j) to f^{T}(u,v,j) in the u×v macroblocks with respect to the j^{th} piece of frame data in the J pieces of frame data. The method of calculating the macroblock texture gradient data f^{T}(1,1,j) to f^{T}(u,v,j) has been described in the second embodiment, so detailed descriptions thereof will be omitted.

Next, as shown in step (h2), the background complexity analyzing module 454 ascends j to perform the step (h1) J times to obtain u×v pieces of macroblock texture gradient data with respect to each of the J pieces of frame data. Thereafter, as shown in step (h3), the background complexity analyzing module 454 calculates the number of the macroblock texture gradient data greater than a texture gradient data threshold value in the J×u×v pieces of macroblock texture gradient data, and divides the number by the parameter 1/(J×u×v) to calculate the background complexity data Bcd. For example, the operations of the steps (h1) to (h3) may be expressed by the following equation:

$$Bcd = \frac{1}{u \times v \times J} {\sum }_{j} {\sum }_{U} {\sum }_{V} U ( {f}^{T} ( U , V , j ) - Tt )$$

wherein Tt is the macroblock texture gradient data threshold value, and U(f^{T}(U,V,j)−Tt) is the unit step function. When the texture gradient data of the macroblock texture gradient data f^{T}(U,V,j) is greater than the texture gradient data threshold value Tt, the value of the unit step function is 1. When the texture gradient data of the macroblock texture gradient data f^{T}(U,V,j) is smaller than or equal to the texture gradient data threshold value Tt, the value of the unit step function is 0. Thereafter, the J×u×v unit step functions are accumulated and then divided by the value J×u×v so that the background complexity data Bcd is obtained.

The depth repairing module 456 further judges whether the background complexity data is greater than a background complexity data threshold value. If so, the depth repairing module 456 judges the input video data Vdi as pertaining to the video data with the high background complexity. If not, the depth repairing module 456 judges the input video data Vdi as pertaining to the video data with the low background complexity.

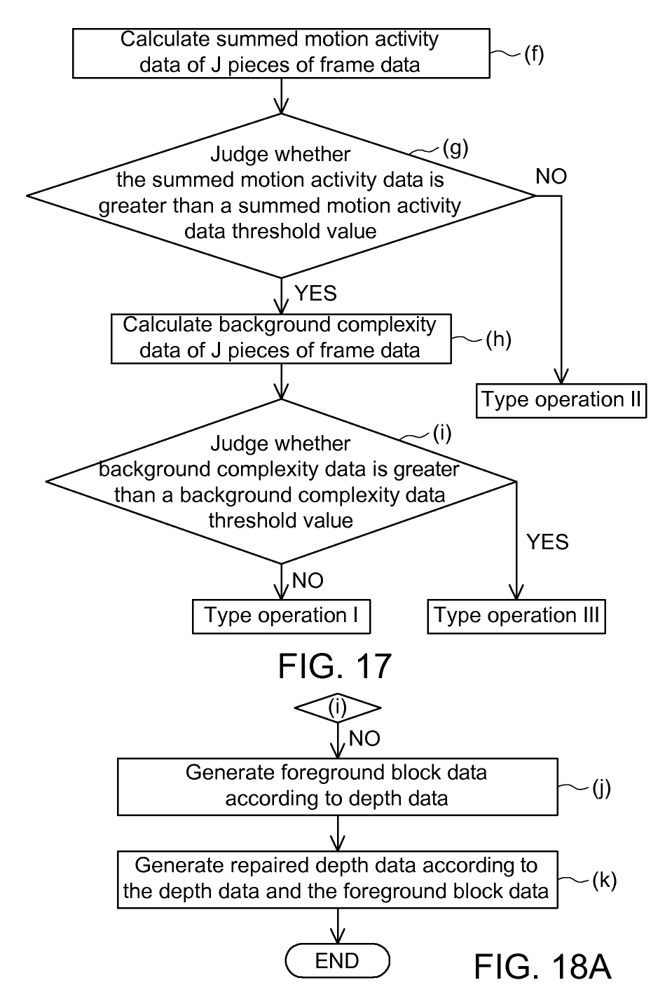

In one example, the operations performed by the video classifying module 450 are listed in the flow chart of FIG. 17. According to the operations of steps (f) to (i), the depth repairing module 456 classifies the input video data Vdi into the video type I with the large motion activity and the simple background, the video type II with the small motion activity or the video type III with the large motion activity and the complicated background. For example, the depth repairing module 456 corrects the input video data Vdi corresponding to the different video types I, II and III through different correction steps. Next, the depth data repair operations performed by the depth repairing module 456 when the input video data Vdi corresponds to the video type I, II and III will be described in the following.

When the input video data Vdi pertains to the video type I, the frame of the input video data Vdi has characteristics of the high motion activity and the low background complexity. In this case, the depth repairing module 456 acquires and repairs the depth data corresponding to the foreground in the input video data Vdi to obtain the better foreground depth data.

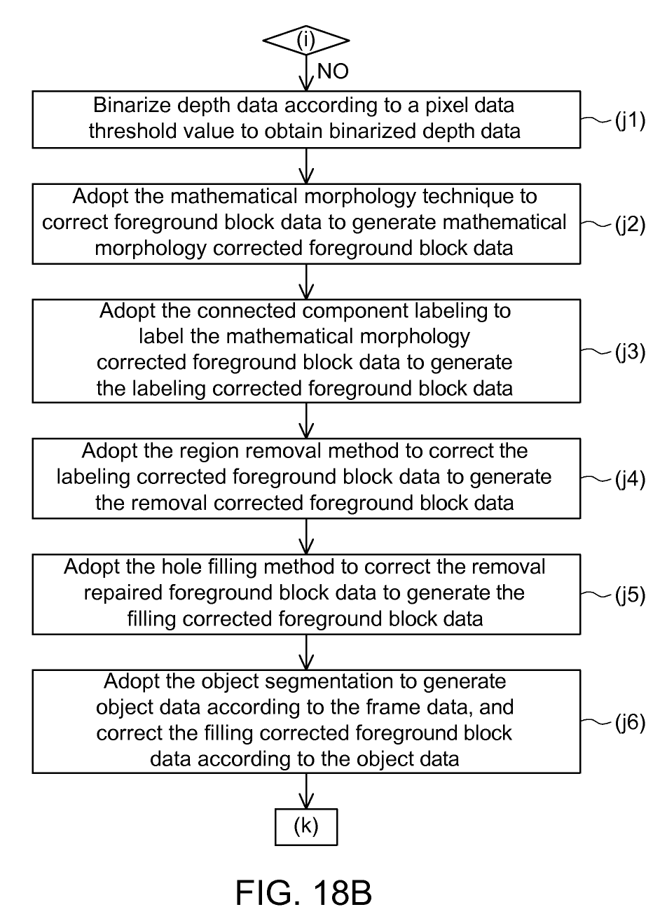

In one example, when the input video data Vdi pertains to the video type I, the operation flow chart of the depth repairing module 456 is shown in FIG. 18A. First, as shown in step (j), the depth repairing module 456 generates the foreground block data Dfd according to the depth data Dd4. Thereafter, as shown in step (k), the depth repairing module 456 generates the repaired depth data Dd4′ according to the depth data Dd4 and the foreground block data Dfd.

In the step (j), the operation of generating the foreground block data Dfd according to the depth data Dd4 may be achieved according to various data processing methods. For example, the depth repairing module 456 binarizes the depth data Dd4 according to a pixel data threshold value so that the depth data with the depth value greater than the pixel data threshold value in the depth data Dd4 is classified into the foreground block data Dfd.

In the step (j), after the foreground block data Dfd is generated, the depth repairing module 456 may further perform several video processing techniques to correct the foreground block data Dfd. For example, the depth repairing module 456 may eliminate the noise influence using the mathematical morphology technique, the connected component labeling technique, the region removal method and the hole filling method so that the foreground profile corresponding to the foreground block data Dfd becomes smooth.

The depth repairing module 456 further adopts the object segmentation technique to correct the foreground block data Dfd with reference to the object information in the input video data Vdi so that the foreground profile of the foreground block data may correspond to the object profile in the actual input video data Vdi. For example, the object segmentation technique may be the Delaunay triangulation technique or the mean shift segmentation technique.

In one example, in the step (j), the depth repairing module 456 sequentially performs the steps (j1) to (j6) to sequentially adopt the binarization technique, the mathematical morphology technique, the connected component labeling, the region removal method, the hole filling method and the object segmentation method to correct the foreground block data Dfd, as shown in FIG. 18B.

In step (k), for example, the depth repairing module 456 assigns each macroblock depth value in the depth data Dd4 as the depth value corresponding to the foreground block. In one example, the depth repairing module 456 assigns the depth value, which is greater than or equal to a foreground depth threshold value (i.e., the depth value corresponding to the depth smaller than or equal to the depth corresponding to the threshold value), to the foreground block data Dfd. When the depth value corresponding to any macroblock in the foreground region is smaller than a foreground depth threshold value (i.e., the corresponding depth is greater than the foreground depth threshold value), the depth repairing module 456 corrects the depth value of this macroblock according to the interpolation result of the peak values (the higher depth value corresponding to the smaller depth) of the depth data of the neighboring macroblocks around this macroblock. Thus, it is possible to prevent the error condition that the assigned foreground region has the too-small depth data value (and the too large depth).

For example, the input video data Vdi is shown in exhibit 1, and the corresponding depth data Dd4 is shown in the exhibit 2.

When the input video data Vdi pertains to the video type II, the frame of the input video data Vdi has the small motion activity (when the background complexity is either high or low). In this case, the depth repairing module 456 judges the motion activity condition of each of the x′×y′ pieces of pixel data in the input video data Vdi with reference to a portion of k pieces of continuous frame data in the input video data Vdi. Thereafter, the depth data Dd4 is corrected according to the motion activity obtained with reference to the k pieces of continuous frame data.

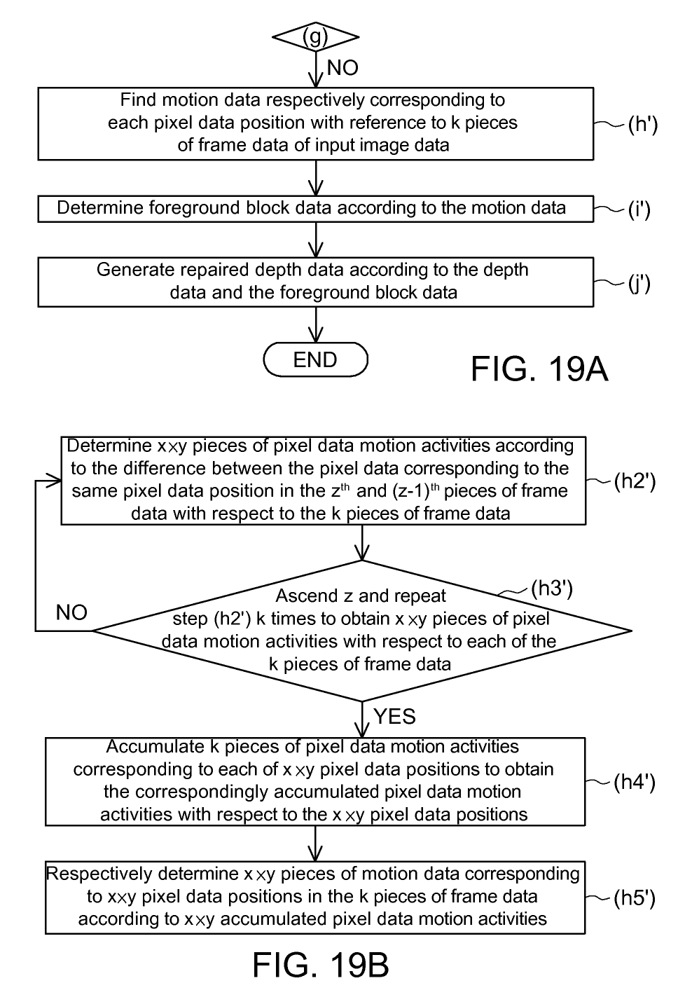

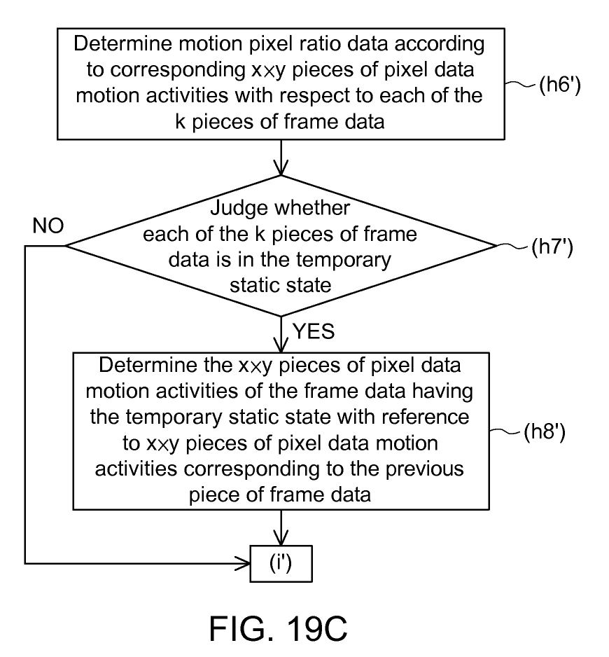

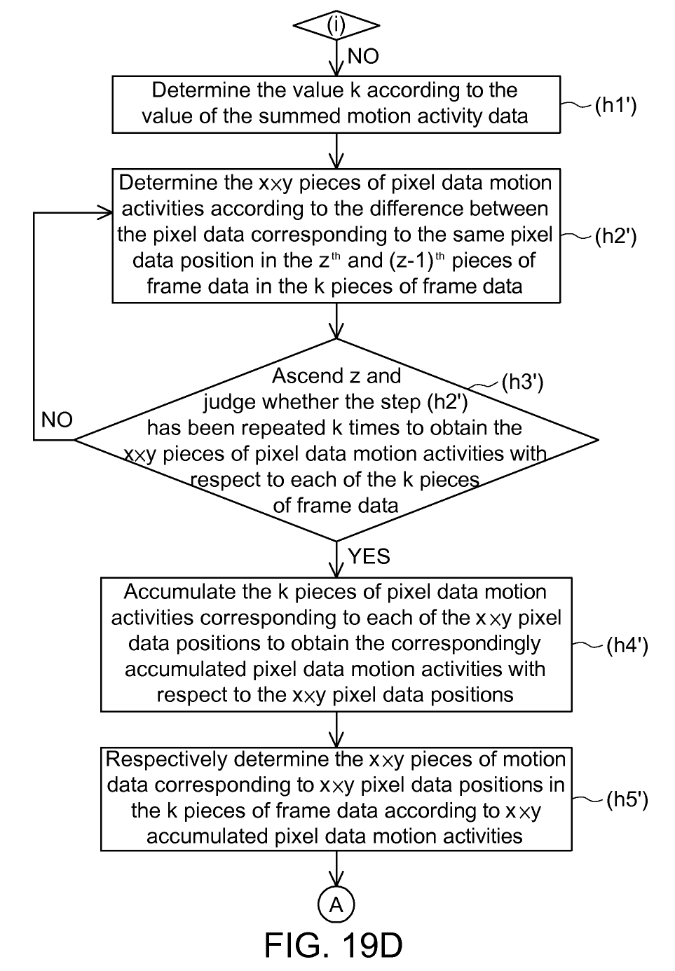

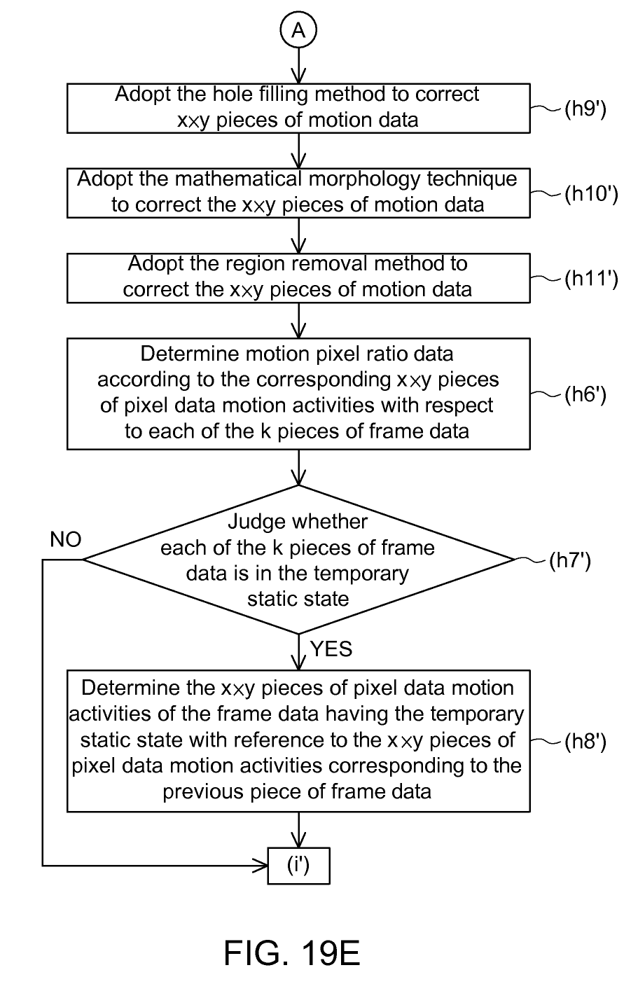

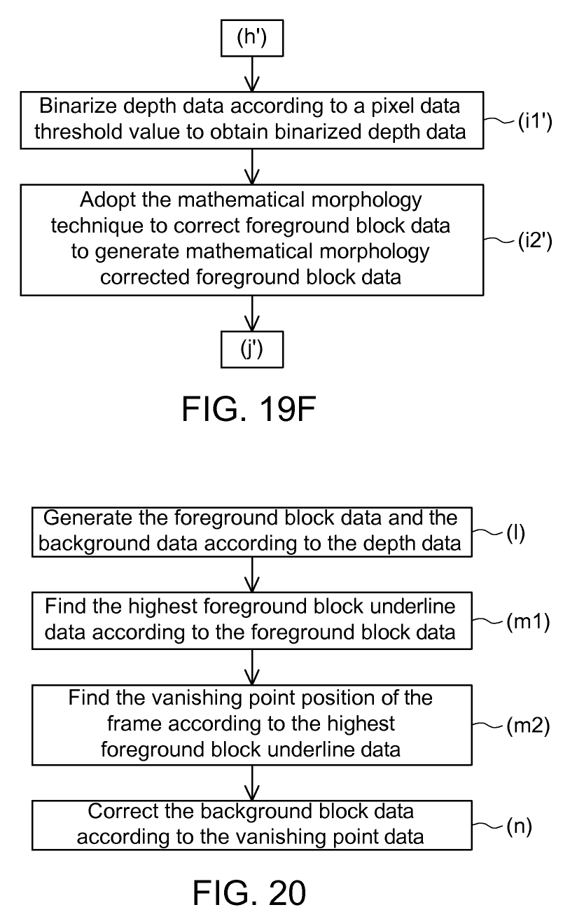

In one example, when the input video data Vdi pertains to the video type II, the operation flow chart of the depth repairing module 456 is shown in FIG. 19A. First, as shown in step (h′), the depth repairing module 456 finds x×y pieces of motion data Md(1,1) to Md(x,y) respectively corresponding to each of the x×y pixel data positions with reference to the k pieces of frame data of the input video data Vdi. Each of the x×y pieces of motion data Md(1,1) to Md(x,y) respectively indicates whether the k pieces of pixel data at the corresponding pixel positions have the motion activity, wherein k is a natural number greater than 1 and smaller than or equal to J.

Next, as shown in step (i′), the depth repairing module 456 determines the foreground block data Dfd according to the x×y motion data Md(1,1) to Md(x,y). Thereafter, as shown in step (j′), the depth repairing module 456 generates the repaired depth data according to the depth data Dd4 and the foreground block data Dfd.

For example, in step (h′), the depth repairing module 456 determines the value k according to the value of the summed motion activity data Smd. In one example, the value k is a function of the summed motion activity data Smd, and the depth repairing module 456 calculates the summed motion activity data Smd through, for example, the equation of calculating the summed motion activity data Smd, and then calculates the value k.

For example, in the step (h′), the depth repairing module 456 calculates the corresponding motion data Md(1,1) to Md(x,y) by accumulating k pieces of pixel data motion activities corresponding to each of the x×y pixel data positions in the k pieces of frame data, as shown in FIG. 19B. As shown in step (h2′), the depth repairing module 456 determines the x×y pieces of pixel data motion activities corresponding to the z^{th} piece of frame data according to the difference between the pixel data corresponding to the same pixel data position in the z^{th} piece of frame data and the (z−1)^{th} piece of frame data of the k pieces of frame data, wherein z is a natural number smaller than or equal to k and greater than 1.

Next, as shown in step (h3′), the depth repairing module 456 ascends z and repeats the step (h2′) k times to obtain the x×y pieces of pixel data motion activities with respect to each of the k pieces of frame data. Then, as shown in step (h4′), the depth repairing module 456 accumulates the k pieces of pixel data motion activities corresponding to each of the x×y pixel data positions to obtain the corresponding accumulated pixel data motion activities Cd(1,1) to Cd(x,y) with respect to each of the x×y pixel data positions. For example, the operations of the steps (h2′) to (h4′) may be expressed by the following equation:

$$Cd ( X , Y ) = {\sum }_{t = 1}^{k} \vert \begin{matrix}I ( X , Y , t ) - \\ I ( X , Y , t - 1 )\end{matrix} \vert \vert X = 1 , 2 , … , x ; Y = 1 , 2 , … , y$$

wherein I(X,Y,t) and I(X,Y,t−1) are respectively the pixel data corresponding to the current frame data, and the pixel data corresponding to the pixel data position (X,Y) in the previous piece of frame data.

Thereafter, as shown in step (h5′), the depth repairing module 456 respectively determines the x×y pieces of motion data Md(1,1) to Md(x,y) corresponding to the x×y pixel data positions in the k pieces of frame data according to x×y pieces of accumulated pixel data motion activities Cd(1,1) to Cd(x,y). For example, the depth repairing module 456 judges whether each of the pieces of accumulated pixel data motion activities Cd(1,1) to Cd(x,y) is greater than a motion activity threshold value. If so, the corresponding motion data Md(1,1) to Md(x,y) are set to indicate that the k pieces of pixel data at the corresponding pixel positions have a specific motion activity. If not, the corresponding motion data Md(1,1) to Md(x,y) are set to indicate that the k pieces of pixel data at the corresponding pixel positions have the zero motion activity.

For example, in the step (h′), the depth repairing module 456 further adopts the hole filling technique, the mathematical technique and the block removing technique to correct the x×y pieces of motion data Md(1,1) to Md(x,y) and thus eliminate the noise influence and make it become more smooth.

For example, in the step (h′), the depth repairing module 456 further detects whether any one piece of frame data in the k pieces of frame data encounters a temporary static state, and thus corrects the x×y pieces of pixel data motion activities corresponding to the frame data. For example, the depth repairing module 456 performs the steps (h6′) to (h8′) to perform the operation of detecting the temporary static state, as shown in FIG. 19C.

As shown in step (h6′), the depth repairing module 456 determines the motion pixel ratio data, which indicates the ratio of the motion pixels to the overall frame data in each piece of frame data, according to corresponding x×y pieces of pixel data motion activities with respect to each of the k pieces of frame data. Next, as shown in step (h7′), the depth repairing module 456 judges whether the m^{th} piece of frame data is in the temporary static state according to the m^{th} piece of motion pixel ratio data corresponding to the m^{th} piece of frame data and the (m−1)^{th} piece of motion pixel ratio data corresponding to the (m−1)^{th} piece of frame data in the k pieces of motion pixel ratio data.

For example, the depth repairing module 456 judges whether the m^{th} piece of frame data encounters the temporary static state by judging whether a ratio difference between the ratios indicated by the m^{th} and (m−1)^{th} pieces of motion pixel ratio data is greater than a ratio threshold value. When the ratio difference between the ratios indicated by the m^{th} and (m−1)^{th} pieces of motion pixel ratio data is smaller than or equal to the ratio threshold value, the depth repairing module 456 judges the m^{th} piece of frame data as being in a dynamic state, and does not correct the x×y pieces of pixel data motion activities of the m^{th} piece of frame data. Thereafter, the step (i′) is performed.

When the ratio difference between the ratios indicated by the m^{th} and (m−1)^{th} pieces of motion pixel ratio data is greater than the ratio threshold value, the depth repairing module 456 judges the m^{th} piece of frame data as being in the temporary static state, and sets the x×y pieces of pixel data motion activities of the m^{th} piece of frame data to be equal to the x×y pieces of pixel data motion activities of the (m−1)^{th} piece of frame data. Then, the step (i′) is performed.

In one example, the depth repairing module 456 sequentially performs the steps (h1′), (h2′) to (h5′), (h9′) to (h11′) and (h6′) to (h8′) in the step (h′), as shown in FIGS. 19D and 19E.

In one example, in the step (i′), the depth repairing module 456 further adopts the object segmentation technique to generate the corresponding object data according to the k pieces of frame data, and correct the foreground block data Dfd according to the object data. For example, the object segmentation technique may be the Delaunay triangulation technique or the mean shift segmentation technique. In another example, in the step (i′), the depth repairing module 456 further adopts the profile smoothing technique to correct the foreground block data Dfd.

For example, in the step (i′), the depth repairing module 456 sequentially performs the steps (i1′) and (i2′) to respectively adopt the object segmentation technique and the profile smoothing technique to correct the foreground block data Dfd, as shown in FIG. 19F.

For example, the input video data Vdi is shown in the exhibit 3, and the corresponding depth data Dd4 is shown in the exhibit 4.

In one example, when the input video data Vdi pertains to the video type III, it is very difficult to effectively acquire the foreground data. Therefore, when the input video data Vdi pertains to the video type III, the depth repairing module 456 does not correct the depth data Dd4 but directly outputs the depth data Dd4 as the repaired depth data Dd4′.

For example, the input video data Vdi is shown in the exhibit 5, and the corresponding depth data Dd4 is shown in the exhibit 6.

In one example, the depth repairing module 456 performs the foreground frame depth estimation operation, and further performs the depth estimation on the background of each frame with reference to the vanishing point data in each frame of the input video data Vdi. Consequently, the depth repairing module 456 may further repair the depth data corresponding to the background frame (e.g., the background frame corresponding to the floor) with the smaller depth in the frame to obtain the ideal depth data Dd4′ with respect to each frame.

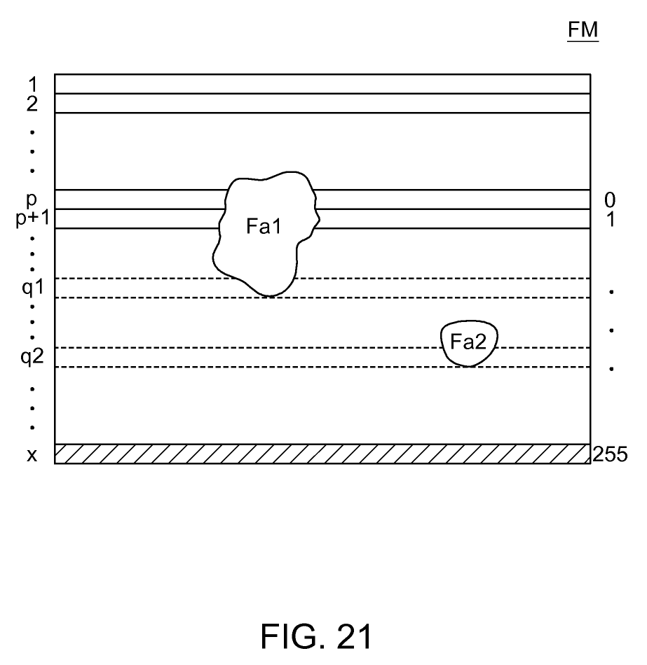

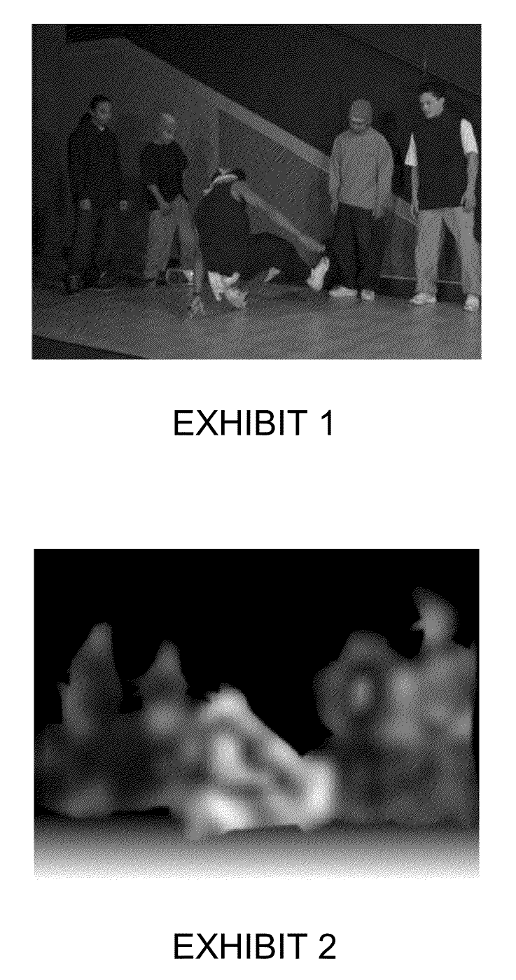

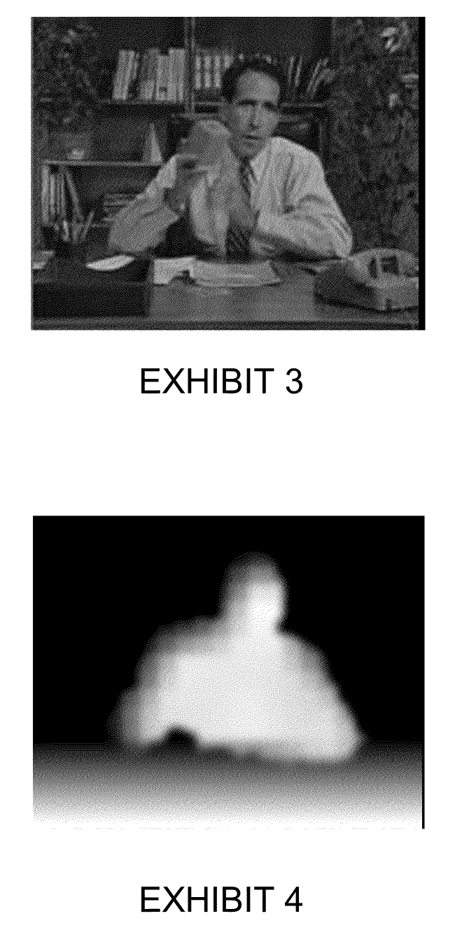

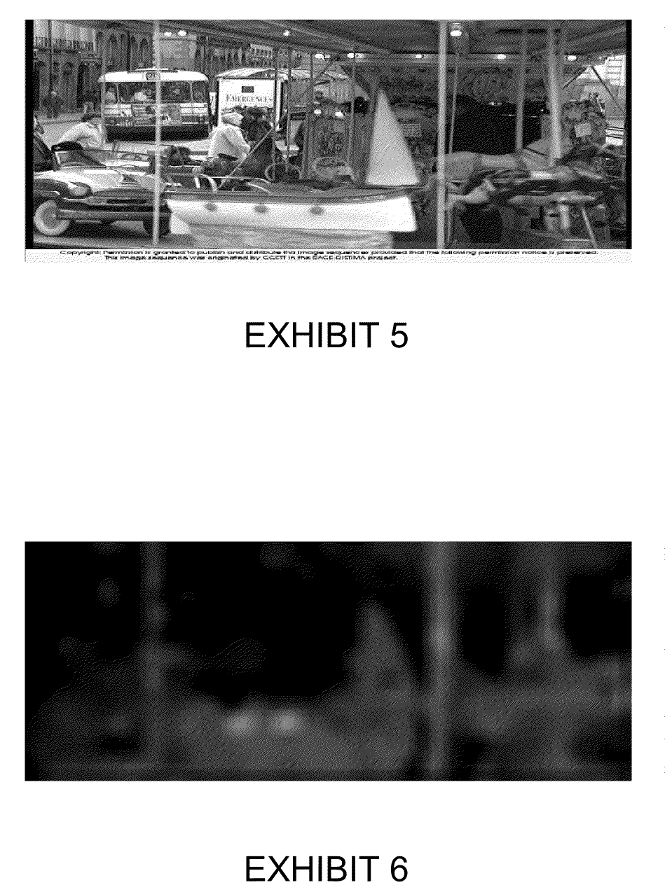

For example, the background depth estimation operation performed by the depth repairing module 456 is shown in FIG. 20. As shown in step (I), the depth repairing module 456 generates the foreground block data Dfd and the background block data Dbd according to the depth data Dd4 with respect to each piece of frame data in the input video data Vdi. Next, as shown in step (m), the depth repairing module 456 generates the vanishing point data for indicating the vanishing point position according to the foreground block data Dfd with respect to each frame data. For example, the vanishing point position corresponds to the p^{th} pixel row position in the frame FM, as shown in FIG. 21, wherein p is a natural number.

In one example, the step (m) includes steps (m1) and (m2). As shown in the step (m1), the depth repairing module 456 finds the highest foreground block underline data, which indicates the highest foreground block underline position, according to the foreground block data Dfd. For example, the underline positions of the foreground blocks Fa1 and Fa2 are respectively the q1^{th} pixel row position and the q2^{th} pixel row position, wherein q1 and q2 are natural numbers greater than p, q1 is smaller than q2, and the highest underline position is the q1^{th} pixel row position, for example.

Next, as shown in step (m2), the depth repairing module 456 finds the vanishing point position of the frame according to the highest foreground block underline data. For example, the highest underline position (the q1^{th} pixel row position) has the height h relative to the lowest pixel row position (the x^{th} pixel row position) of the frame, and the vanishing point position (the p^{th} pixel row position) has the height equal to h/w relative to the highest underline position, wherein w is a natural number greater than 1. In one example, w is equal to 10, and the height of the vanishing point position relative to the highest underline position is equal to h/10.

Thereafter, as shown in step (n), the depth repairing module 456 corrects the background block data Dbd according to the vanishing point data. For example, the depth repairing module 456 respectively fills the ascending depth values from the depth value (i.e., the value 0) corresponding to the maximum depth to the depth value (i.e., the value 255) corresponding to the minimum depth in the background region (e.g., having 255 rows of pixel data) from the vanishing point position (i.e., the p^{th} pixel row position) to the lowest pixel row position (i.e., the x^{th} pixel row position) of the frame, as shown in FIG. 21. In this exemplary embodiment, only the condition that the motion activity analyzing module 452 generates the summed motion activity data Smd with respect to all the J pieces of frame data of the input video data Vdi is illustrated as an example. However, the motion activity analyzing module 452 of this embodiment is not limited thereto. In other examples, the motion activity analyzing module 452 may also calculate the corresponding summed motion activity data on a portion of the frame data in the input video data Vdi, and the depth repairing module 456 only classifies the portion of frame data according to the video property.

In one example, the motion activity analyzing module 452 may also divide the J pieces of frame data of the input video data Vdi into many portions, and respectively performs the calculations of summating the motion data multiple times, and the depth repairing module 456 correspondingly classifies the input frame data Vdi many times according to the video property.

Similarly, the background complexity analyzing module 454 of this exemplary embodiment may also perform the corresponding background complexity calculation on a portion of the frame data in the input video data Vdi, or divide the input video data Vdi into many portions and respectively calculate the background complexity data many times.

Different from the depth calculating methods of the first and second exemplary embodiments, the depth calculating method of this exemplary embodiment further analyzes the motion activity of the input video data and the frame background complexity level to classify the possible input video data into three video categories. The depth calculating method of this exemplary embodiment further performs different foreground depth data repair operations on the input video data pertaining to different video classifications according to classification result. Thus, compared with the conventional depth data generating method, the depth calculating method of this exemplary embodiment has the advantages of performing different adaptive foreground depth repair operations on the input video data having different properties, and of enhancing the precision of the depth data.

In addition, the depth calculating method of this exemplary embodiment may further perform the background depth correction on the input video data according to the vanishing point data. Thus, compared with the conventional depth data generating method, the depth calculating method of this embodiment further has the advantages of performing the correction operation on the background depth of the input video data and of enhancing the precision of the depth data.

The depth calculating method of each exemplary embodiment of the disclosure is for generating the depth data of the corresponding frame data. The depth calculating method of the disclosure may further perform the application operation of generating a two-eye three-dimensional (3D) video signal or a multi-viewing-angle video signal or the application operation of encoding and decoding the 3D video signal according to the depth data.

While the disclosure has been described by way of examples and in terms of disclosed embodiments, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A depth calculating method for calculating corresponding depth data in response to frame data of input video data, the frame data comprising u×v macroblocks, each of the u×v macroblocks comprising X×Y pieces of pixel data, wherein u and v are natural numbers greater than 1, the depth calculating method comprising the steps of:
(a1) finding smooth macroblocks in the u×v macroblocks;
(a2) setting motion vector data of the smooth macroblocks in the u×v macroblocks as corresponding to a zero motion vector;
(a3) finding a plurality of neighboring macroblocks with respect to each of the u×v macroblocks;
(a4) setting motion vector data of each of the u×v macroblocks to be equal to mean motion vector data of the neighboring macroblocks;
(a5) finding u×v pieces of macroblock motion parallax data corresponding to the respective u×v macroblocks according to the corrected motion vector data of the u×v macroblocks after the steps (a2) and (a4); and
(b) calculating the depth data corresponding to the frame data according to the u×v pieces of macroblock motion parallax data.

2. The method according to claim 1, further comprising the steps of (c) calculating u×v pieces of macroblock variance data corresponding to the u×v macroblocks, wherein the step (b) further calculates the depth data corresponding to the frame data according to the u×v pieces of macroblock variance data.

3. The method according to claim 2, wherein the step (c) comprises:
(c1) calculating u×v pieces of mean macroblock pixel data respectively corresponding to the u×v macroblocks;
(c2) finding X×Y pieces of data differences of each of the X×Y pieces of pixel data corresponding to the mean macroblock pixel data with respect to each of the u×v macroblocks;
(c3) finding a mean pixel difference of the X×Y pieces of data differences with respect to each of the u×v macroblocks; and
(c4) generating the u×v pieces of macroblock variance data according to the mean pixel differences corresponding to the respective u×v macroblocks.

4. The method according to claim 2, wherein the step (b) comprises:
(b1) obtaining reference depth data with respect to the frame data;
(b2) deriving a first weighting coefficient and a second weighting coefficient using a pseudo-inverse matrix according to the reference depth data, the u×v pieces of macroblock motion parallax data and the u×v pieces of macroblock variance data; and
(b3) generating the depth data approximating the reference depth data by summing the u×v pieces of macroblock motion parallax data, which are weighted according to the first coefficient and the corresponding u×v pieces of macroblock variance data, which are weighted according to the second coefficient.

5. The method according to claim 1, further comprising the step of:
(d) calculating u×v pieces of contrast data corresponding to the u×v macroblocks;
wherein the step (b) further calculates the depth data corresponding to the frame data according to the u×v pieces of contrast data.

6. The method according to claim 5, wherein the step (d) comprises:
(d1) finding maximum value pixel data and minimum value pixel data with respect to each of the u×v macroblocks;
(d2) calculating differential pixel data between the maximum value and minimum value pixel data and summated pixel data of the maximum value and minimum value pixel data with respect to each of the u×v macroblocks; and
(d3) using a ratio of the differential pixel data to the summated pixel data as corresponding macroblock contrast data with respect to each of the u×v macroblocks.

7. The method according to claim 5, wherein the step (b) comprises:
(b1) obtaining reference depth data with respect to the frame data;
(b2) deriving a first weighting coefficient and a second weighting coefficient using a pseudo-inverse matrix according to the reference depth data, the u×v pieces of macroblock motion parallax data and the u×v pieces of macroblock contrast data; and
(b3) generating the depth data approximating the reference depth data by summing the u×v pieces of macroblock motion parallax data, which are weighted according to the first coefficient and the corresponding u×v pieces of macroblock contrast data, which are weighted according to the second coefficient.

8. The method according to claim 1, further comprising the step of:
(e) calculating u×v pieces of macroblock texture gradient data corresponding to the u×v macroblocks;
wherein the step (b) further calculates the depth data corresponding to the frame data according to the u×v pieces of texture gradient data.

9. The method according to claim 8, wherein the step (e) comprises:
(e1) calculating an i^{th} piece of sub-texture gradient data according to an i^{th} texture gradient mask and corresponding pixel data of each of the u×v macroblocks with respect to each of the X×Y pieces of pixel data of each of the u×v macroblocks, wherein an initial value of i is 1;
(e2) ascending i and repeating the step (e1) I times to correspondingly obtain I pieces of sub-texture gradient data;
(e3) summating absolute values of the I pieces of sub-texture gradient data to obtain one piece of texture gradient data with respect to each of the X×Y pieces of pixel data of each of the u×v macroblocks; and
(e4) calculating the number of pieces of pixel data having the texture gradient data greater than a texture gradient data threshold value within each of the u×v macroblocks to generate corresponding macroblock texture gradient data with respect to each of the u×v macroblocks.

10. The method according to claim 9, wherein the step (b) comprises:
(b1) obtaining reference depth data with respect to the frame data;
(b2) deriving a first weighting coefficient and a second weighting coefficient using a pseudo-inverse matrix according to the reference depth data, the u×v pieces of motion parallax data and the u×v pieces of macroblock texture gradient data; and
(b3) generating the depth data approximating the reference depth data by summing the u×v pieces of macroblock motion parallax data, which are weighted according to the first coefficient and the corresponding u×v pieces of macroblock texture gradient data, which are weighted according to the second coefficient.

11. The method according to claim 1, wherein:
the input video data comprises J pieces of frame data, each of the J pieces of frame data comprises x×y pieces of pixel data, J is a natural number greater than 1, and x and y are substantially equal to a product of X and u and a product of Y and v, respectively; and
the depth calculating method further comprises the step of:
(f) calculating summed motion activity data of the J pieces of frame data;
(g) judging whether the summed motion activity data is greater than a summed motion activity data threshold value, and performing the step (h) if yes;
(h) calculating background complexity data of the J pieces of frame data; and
(i) judging whether the background complexity data is greater than a background complexity data threshold value, and performing the step (a1) if yes.

12. The method according to claim 11, wherein in the step (i), if the background complexity data is judged as smaller than or equal to the background complexity data threshold value, the following steps are performed:
(j) generating foreground block data according to the depth data; and
(k) generating repaired depth data according to the depth data and the foreground block data.

13. The method according to claim 12, wherein the step (j) comprises:
(j1) binarizing the depth data according to a pixel data threshold value to obtain binarized depth data comprising the foreground block data.

14. The method according to claim 12, wherein the step (j) comprises:
(j2) correcting the foreground block data using mathematical morphology technique.

15. The method according to claim 12, wherein the step (j) comprises:
(j3) labeling the foreground block data using connected component labeling technique to correct the foreground block data.

16. The method according to claim 12, wherein the step (j) comprises:
(j4) removing a portion of the foreground block data having corresponding block dimensions smaller than a block dimension threshold value using a region removal method to correct the foreground block data.

17. The method according to claim 12, wherein the step (j) comprises:
(j5) filling a portion of the foreground block data having holes using a hole filling method to correct the foreground block data.

18. The method according to claim 12, wherein the step (j) comprises:
(j6) generating object data according to the frame data using an object segmentation method, and correcting the foreground block data according to the object data.

19. The method according to claim 12, wherein the step (j) comprises:
(j1) binarizing the depth data according to a pixel data threshold value to obtain binarized depth data, which comprises the foreground block data;
(j2) correcting the foreground block data using mathematical morphology technique to generate mathematically modified foreground block data;
(j3) labeling the mathematically modified foreground block data using connected component labeling technique to generate labeling corrected foreground block data;
(j4) correcting the labeling repaired foreground block data using a region removal method to generate removal corrected foreground block data;
(j5) correcting the removal repaired foreground block data using a hole filling method to generate filling corrected foreground block data; and
(j6) generating object data according to the frame data using an object segmentation method, and correcting the filling repaired foreground block data according to the object data to correct the foreground block data.

20. The method according to claim 11, wherein in the step (g), if the summed motion activity data is judged as smaller than or equal to the summed motion activity data threshold value, the following steps are performed:
(h′) finding x×y pieces of motion data respectively corresponding to each of x×y pixel data positions with reference to k pieces of frame data of the input video data, wherein each of the x×y pieces of motion data respectively indicates whether motion activity takes place on the k pieces of pixel data corresponding to each of the x×y pixel positions, and k is a natural number greater than 1 and smaller than or equal to J;
(i′) determining foreground block data according to levels of the x×y pieces of motion data; and
(j′) generating repaired depth data according to the depth data and the foreground block data.

21. The method according to claim 20, wherein the step (h′) comprises:
(h1′) determining the value k according to a level of the summed motion activity data.

22. The method according to claim 20, wherein the step (h′) comprises:
(h2′) determining x×y pieces of pixel data motion activities as corresponding to the z^{th} piece of frame data according to a difference between pixel data corresponding to the same pixel data position in a z^{th} piece of frame data and a (z−1)^{th} piece of frame data of the k pieces of frame data, wherein z is a natural number smaller than or equal to k and is greater than 1, and an initial value of z is 2;
(h3′) ascending z and repeating the step (h2′) k times to obtain the x×y pieces of pixel data motion activities with respect to each of the k pieces of frame data;
(h4′) accumulating k pieces of pixel data motion activities corresponding to each of the x×y pixel data positions to obtain an accumulated pixel data motion activity with respect to each of the x×y pixel data positions; and
(h5′) determining x×y pieces of motion data, corresponding to the pixel data position, in the k pieces of frame data according to the x×y accumulated pixel data motion activities.

23. The method according to claim 22, wherein the step (h′) comprises:
(h6′) determining a piece of motion pixel ratio data according to the corresponding x×y pieces of pixel data motion activities with respect to each of the k pieces of frame data; and
(h7′) judging whether an m^{th} piece of frame data has a temporary static state according to an m^{th} piece of motion pixel ratio data corresponding to the m^{th} piece of frame data and an (m−1)^{th} piece of motion pixel ratio data corresponding to an (m−1)^{th} piece of frame data in the k pieces of motion pixel ratio data, and performing the step (i′) if not, wherein m is a natural number smaller than or equal to k and greater than 1.

24. The method according to claim 23, wherein after the step (h7′), if the m^{th} piece of frame data is judged as having the temporary static state, the following steps are performed:
(h8′) determining x×y pieces of pixel data motion activities corresponding to the m^{th} piece of frame data with reference to x×y pieces of pixel data motion activities corresponding to the (m−1)^{th} piece of frame data.

25. The method according to claim 20, wherein the step (h′) comprises:
(h9′) correcting the x×y pieces of motion data using a hole filling method.

26. The method according to claim 20, wherein the step (h′) comprises:
(h10′) correcting the x×y pieces of motion data using mathematical morphology technique.

27. The method according to claim 20, wherein the step (h′) comprises:
(h11′) correcting the x×y pieces of motion data using a region removal method.

28. The method according to claim 20, wherein the step (i′) comprises:
(i1′) generating object data according to the frame data using an object segmentation method and correcting the foreground block data according to the object data.

29. The method according to claim 20, wherein the step (i′) comprises:
(i2′) correcting the foreground block data using profile smoothing technique.

30. The method according to claim 20, wherein the step (h′) comprises:
(h1′) determining the value k according to a level of the summed motion activity data;
(h2′) determining x×y pieces of pixel data motion activities as corresponding to the z^{th} piece of frame data according to a difference between pixel data corresponding to the same pixel data position in a z^{th} piece of frame data and a (z−1)^{th} piece of frame data of the k pieces of frame data, wherein z is a natural number smaller than or equal to k and is greater than 1, and an initial value of z is 2;
(h3′) ascending z and repeating the step (h1′) k times to obtain the x×y pieces of pixel data motion activities with respect to each of the k pieces of frame data;
(h4′) accumulating k pieces of pixel data motion activities corresponding to each of the x×y pixel data positions to obtain an accumulated pixel data motion activity with respect to each of the x×y pixel data positions;
(h5′) determining x×y pieces of motion data, corresponding to the pixel data position, in the k pieces of frame data according to the x×y accumulated pixel data motion activities;
(h6′) determining a piece of motion pixel ratio data according to the corresponding x×y pieces of pixel data motion activities with respect to each of the k pieces of frame data;
(h7′) judging whether an m^{th} piece of frame data has a temporary static state according to an m^{th} piece of motion pixel ratio data corresponding to the m^{th} piece of frame data and an (m−1)^{th} piece of motion pixel ratio data corresponding to an (m−1)^{th} piece of frame data in the k pieces of motion pixel ratio data, and performing the step (i′) if not or otherwise performing step (h8′), wherein m is a natural number smaller than or equal to k and greater than 1;
(h8′) determining the x×y pieces of pixel data motion activities corresponding to the m^{th} piece of frame data with reference to the x×y pieces of pixel data motion activities corresponding to the (m−1)^{th} piece of frame data;
(h9′) correcting the x×y pieces of motion data using a hole filling method;
(h10′) correcting the x×y pieces of motion data using mathematical morphology technique; and
(h11′) correcting the x×y pieces of motion data using a region removal method.

31. The method according to claim 20, wherein the step (i′) comprises:
(i1′) generating object data according to the frame data using an object segmentation method and correcting the foreground block data according to the object data; and
(i2′) correcting the foreground block data using profile smoothing technique.

32. The method according to claim 11, wherein the step (f) comprises:
(f1) calculating x×y pieces of pixel data differences between x×y pieces of pixel data of a j^{th} piece of frame data of the pieces of frame data and x×y pieces of pixel data corresponding to the same position in a (j−1)^{th} piece of frame data of the pieces of frame data, wherein j is a natural number smaller than or equal to J, and an initial value of j is 1;
(f2) calculating a data amount of the x×y pieces of pixel data differences greater than a pixel data difference threshold value to generate a j^{th} piece of difference data;
(f3) ascending j to repeat the steps (f1) and (f2) J times to correspondingly obtain J pieces of difference data; and
(f4) obtaining the summed motion activity data according to the J pieces of difference data.

33. The method according to claim 11, wherein the step (h) comprises:
(h1) calculating u×v pieces of macroblock texture gradient data of the u×v macroblocks with respect to a j^{th} piece of frame data of the J pieces of frame data, wherein j is a natural number smaller than or equal to J, and an initial value of j is 1;
(h2) ascending j to perform the step (h1) J times to obtain the u×v pieces of macroblock texture gradient data with respect to each of the J pieces of frame data; and
(h3) calculating the number of pieces of macroblock texture gradient data of J×u×v pieces of macroblock texture gradient data greater than a texture gradient data threshold value to generate the background complexity data.

34. The method according to claim 1, further comprising the steps of:
(l) generating background block data and foreground block data according to the depth data;
(m) generating vanishing point data according to the foreground block data with respect to the frame data; and
(n) correcting the background block data according to the vanishing point data.

35. The method according to claim 34, wherein the step (m) comprises:
(m1) finding highest foreground block underline data according to the foreground block data; and
(m2) calculating the vanishing point data according to the highest foreground block underline data.

36. The method according to claim 1, wherein the step (a5) comprises:
(a51) performing a histogram operation on the frame data and the previous piece of frame data to judge whether the frame data and the previous piece of frame data correspond to a shot change operation, and performing the step (b) if not.

37. The method according to claim 36, wherein in the step (a51), if the frame data and the previous piece of frame data are judged as corresponding to the shot change operation, the motion vector data of the frame data is determined with reference to the frame data and next n pieces of frame data, wherein n is a natural number.

38. The method according to claim 1, wherein the step (a5) comprises:
(a52) correcting the u×v pieces of macroblock motion parallax data using a camera motion refinement.

39. The method according to claim 1, wherein:
the input video data is obtained by decompression using a standard decompression format, and the standard decompression format further provides motion vector information; and
the depth calculating method further comprises:
(a53) correcting the u×v pieces of macroblock motion parallax data using the motion vector information.

40. A depth calculating apparatus for calculating corresponding depth data in response to frame data of input video data, the frame data comprising u×v macroblocks, each of the u×v macroblocks comprising X×Y pieces of pixel data, wherein u and v are natural numbers greater than 1, the depth calculating apparatus comprising:
a motion parallax data module for generating u×v pieces of macroblock motion parallax data according to motion vector data corresponding to the u×v macroblocks, wherein the motion parallax data module comprises:
a region correcting module for finding smooth macroblocks in the u×v macroblocks and setting the motion vector data of the smooth macroblocks in the u×v macroblocks as corresponding to a zero motion vector;
a motion vector data correcting module for finding a plurality of neighboring macroblocks with respect to each of the u×v macroblocks, and setting the motion vector data of each of the u×v macroblocks to be equal to mean motion vector data of the neighboring macroblocks; and
a motion parallax data calculating module for generating the u×v pieces of macroblock motion parallax data according to the macroblock motion vector data of the u×v macroblocks, corrected by the region correcting module and the motion vector data correcting module; and
a depth calculating module for calculating the depth data corresponding to the frame data according to the u×v pieces of macroblock motion parallax data.

41. The apparatus according to claim 40, further comprising:
a parameter module for calculating u×v pieces of macroblock variance data corresponding to the u×v macroblocks;
wherein the depth calculating module further calculates the depth data corresponding to the frame data according to the u×v pieces of macroblock variance data.

42. The apparatus according to claim 40, further comprising:
a parameter module for calculating u×v pieces of macroblock contrast data corresponding to the u×v macroblocks;
wherein the depth calculating module further calculates the depth data corresponding to the frame data according to the u×v pieces of macroblock contrast data.

43. The apparatus according to claim 40, further comprising:
a parameter module for calculating u×v pieces of macroblock texture gradient data corresponding to the u×v macroblocks;
wherein the depth calculating module further calculates the depth data corresponding to the frame data according to the u×v pieces of macroblock texture gradient data.

44. The apparatus according to claim 40, wherein:
the input video data comprises J pieces of frame data, each of the J pieces of frame data comprises x×y pieces of pixel data, J is a natural number greater than 1, and x and y are substantially equal to a product of X and u and a product of Y and v, respectively; and
the depth calculating apparatus further comprises a video classifying module, which comprises:
a motion activity analyzing module for calculating summed motion activity data of the J pieces of frame data;
a background complexity analyzing module for calculating summed motion activity data of the J pieces of frame data; and
a depth repairing module for judging whether the summed motion activity data is greater than a summed motion activity data threshold value, judging whether the background complexity data is greater than a background complexity data threshold value, and thus determining a video classification of the input video data, wherein the depth repairing module further repairs the depth data corresponding to each of the J pieces of frame data according to the video classification.
